(19) United States
(12) Patent Application Publication
(10) Pub. No.: US 2010/0272938 A1
(43) Pub. Date: Oct. 28, 2010

(54) Hydraulically-Formed Nonwoven Sheet with Microfibers

(75) Inventors: Melvin Glenn Mitchell, Penrose, NC (US); Marvin Lynn Mitchell, Parker, CO (US); Christopher Rene Jansen, Kaukauna, WI (US); Paula Hines Mitchell, Parker, CO (US); Amber Layne Wolfe, Landrum, SC (US)

Correspondence Address: BEMIS COMPANY, INC.;Patent and Trademark Department, 2200 BADGER AVENUE, OSHKOSH, WI, 54904, US

(73) Assignee: Bemis Company, Inc., Neenah, WI (US)

(21) Appl. No.: 12/428,300

(22) Filed: Apr. 22, 2009

(51) Int. Cl. B32B 27/02; D04H 1/00; B32B 5/26; B32B 1/02; D21H 13/10; B65B 11/50; B65B 31/02

(52) U.S. Cl. 428/36.1; 442/335; 442/57; 428/219; 428/196; 162/146; 162/123; 53/433; 53/463

(57) ABSTRACT

In a first embodiment, a hydraulically-formed nonwoven sheet, a package comprising such sheet, a method of packaging a medical device using a package with such sheet and a method of manufacturing such sheet are provided. This nonwoven sheet comprises first and second non-cellulosic polymeric fibers. The first non-cellulosic polymeric fibers have an average diameter less than about 3.5 micron, an average cut length less than about 3 millimeters and an average aspect ratio of about 400 to about 2000; the second non-cellulosic polymeric fibers have an average diameter greater than about 3.5 micron and an average aspect ratio of about 400 to about 1000. In a second embodiment, a hydraulically-formed nonwoven sheet is provided. This nonwoven sheet comprises binding material, non-cellulosic polymeric fibers and cellulosic based materials. The non-cellulosic polymeric fibers have an average diameter less than about 3.5 micron, an average cut length less than about 3 millimeters and an average aspect ratio of about 400 to about 2000. The second nonwoven sheet has a bacterial filtration efficiency of at least about 98%.

### BACKGROUND OF THE INVENTION

This present application relates to hydraulically-formed nonwoven sheets, specifically, hydraulically-formed nonwoven sheets with non-cellulosic polymeric fibers.

Nonwoven sheets may be produced via various processes. In the hydraulically-formed or wet-laid process, a nonwoven sheet is produced by filtering an aqueous suspension of fiber. In the air-laid process, fibers are dispersed into a fast moving air stream and condensed onto a moving screen by means of pressure or vacuum. In the carded or dry-laid process, fibers are aligned either parallel or randomly in the direction that a carding machine produces the sheet. In the electrostatically-laid process, an electrostatic field from a polymer solution, polymer emulsion or polymer met is used. In the spunlaced or hydroentangling process, fibers are interlocked and entangled by high velocity streams of water. In spunlaid processes (such as flash spun, melt blown, melt spun or spunbond), a polymeric melt of solution is extruded through spinnerets to form filaments which are laid down on a moving screen.

An example of a product produced via a spunlaid process is Tyvek®, a sheet of continuous polyethylene fibers sold by E.I. du Pont de Nemours and Company (Wilmington, Del.). Tyvek® sheets are used as envelopes, protective barriers, protective clothing, house wrap and packaging, including sterilizable medical packaging. Tyvek® sheets possess acceptable bacterial filtration efficiency and strength properties. However, it is known that variation inherent in Tyvek® sheets present challenges in the converting and use of Tyvek® sheets for sterilizable medical packaging.

It is also known that nonwoven sheets produced via the hydraulically-formed process have reduced variability and enhanced uniformity and formation. This is, in part, because hydraulic suspension allows for the dispersion of discrete, discontinuous fibers of varying aspect ratio (i.e., ratio of length to diameter). However, the hydraulically-formed process presents obstacles when synthetic, non-cellulosic, polymeric fibers are used. In general, synthetic fibers are longer, stronger, more uniform and less compatible with water (an essential component of the hydraulically-formed process) than natural fibers, generally resulting in sheets with variation issues (due, in part, to flocculation). Hydraulically-formed sheets combining cellulosic-based fibers and synthetic, non-cellulosic, polymeric fibers are known. However, due to variation and processing issues, the percentage of synthetic fibers in these sheets is usually minimal.

The present invention addresses the need for a hydraulically-formed nonwoven sheet comprising non-cellulosic polymeric fibers. Specifically, the sheet described in the present application includes polymeric fibers of micron and sub-micron size and has high strength, high air permeability, high bacterial filtration efficiency and reduced variability. The sheet of the present invention may be used to package a variety of items including food and non-food articles (including but not limited to medical devices). It may also be used as a substrate for envelopes, protective barriers, protective clothing, house wrap, filtration media, printing and labels and as an active carrier sheet to supply or transfer functional materials to other surfaces or products.

### BRIEF SUMMARY OF THE INVENTION

The present invention comprises a uniquely-composed hydraulically-formed nonwoven sheet. In a first general embodiment, this hydraulically-formed nonwoven sheet comprises (1) first non-cellulosic polymeric fibers in an amount of from about 5% to about 90% by weight of the nonwoven sheet in its dry state and (2) second non-cellulosic polymeric fibers in an amount of from about 10% to about 95% by weight of the nonwoven sheet in its dry state. The first non-cellulosic polymeric fibers have an average diameter less than about 3.5 micron, an average cut length less than about 3 millimeters and an average aspect ratio of about 400 to about 2000, and the second non-cellulosic polymeric fibers have an average diameter greater than about 3.5 micron and an average aspect ratio of about 400 to about 1000. Additional fibers and materials may be added to this nonwoven sheet. This inventive nonwoven sheet may be mono-layer or multi-layer.

In another embodiment of the first general embodiment, the hydraulically-formed nonwoven sheet comprises (1) binding material in an amount of from about 5% to about 40% by weight of the nonwoven sheet in its dry state, (2) first non-cellulosic polymeric fibers in an amount of from about 10% to about 50% by weight of the nonwoven sheet in its dry state, (3) second non-cellulosic polymeric fibers in an amount of from about 20% to about 65% by weight of the nonwoven sheet in its dry state, (4) third non-cellulosic polymeric fibers in an amount of from about 5% to about 30% by weight of the nonwoven sheet in its dry state and (5) cellulosic based materials in an amount of from about 5% to about 35% by weight of the nonwoven sheet in its dry state. The first non-cellulosic polymeric fibers have an average diameter less than about 3.5 micron, an average cut length less than about 3 millimeters and an average aspect ratio of about 400 to about 2000; the second non-cellulosic polymeric fibers have an average diameter greater than about 3.5 micron and an average aspect ratio of about 400 to about 1000; the third non-cellulosic polymeric fibers have an average diameter greater than about 10 micron and an average cut length of greater than about 5 millimeters; and the cellulosic based materials comprise (a) fibers manufactured from cellulose, (b) naturally occurring cellulosic materials selected from hardwood fibers, softwood fibers, non-wood fibers or blends thereof or (c) blends of fibers manufactured from cellulose and naturally occurring cellulosic materials. Additional fibers and materials may be added to this nonwoven sheet. This inventive nonwoven sheet may be mono-layer or multi-layer.

In yet another embodiment of the first general embodiment, the hydraulically-formed nonwoven sheet comprises (1) binding material in an amount of about 5% to about 30% by weight of the nonwoven sheet in its dry state, (2) first polyester fibers in an amount of from about 10% to about 35% by weight of the nonwoven sheet in its dry state, (3) second polyester fibers in an amount of from about 25% to about 65% by weight of the nonwoven sheet in its dry state, (4) third polyester fibers in an amount of from about 5% to about 20% by weight of the nonwoven sheet in its dry state, and (5) fibers manufactured from cellulose in an amount of from about 5% to about 20% by weight of the nonwoven sheet in its dry state. The first polyester fibers have an average diameter of about 2.5 micron and an average cut length of about 1.5 millimeters and are oriented; the second polyester fibers have an average diameter of about 7 microns and an average cut length of about 5 millimeters and are oriented; the third polyester fibers have an average diameter greater than about 10 micron and an average cut length of greater than about 5 millimeters and are oriented; and the fibers manufactured from cellulose are nano-fibrillated. This nonwoven sheet has a basis weight of from about 50 grams/meter2 to about 100 grams/meter², an air permeability of at least about 100 Coresta units, a formation of about 500 or less, a bacterial filtration efficiency of at least about 99%, a bursting strength of at least about 120 pounds force per square inch gauge, an average internal tearing resistance of at least about 275 grams, a slow rate penetration resistance of at least about 40 Newtons, an average tensile strength of at least about 7 kilograms/15 millimeters and an average stretch of at least about 11% and is a porous packaging material having a log reduction value of at least about 3. Additional fibers and materials may be added to this nonwoven sheet. This inventive nonwoven sheet may be mono-layer or multi-layer.

In still another embodiment of the first general embodiment, a package for an article is described. This package comprises a hydraulically-formed nonwoven sheet with (1) first non-cellulosic polymeric fibers in an amount of from about 5% to about 90% by weight of the nonwoven sheet in its dry state and (2) second non-cellulosic polymeric fibers in an amount of from about 10% to about 95% by weight of the nonwoven sheet in its dry state. The first non-cellulosic polymeric fibers of the nonwoven sheet have an average diameter less than about 3.5 micron, an average cut length less than about 3 millimeters and an average aspect ratio of about 400 to about 2000; and the second non-cellulosic polymeric fibers of the nonwoven sheet have an average diameter greater than about 3.5 micron and an average aspect ratio of about 400 to about 1000. Additional layers may be adhered to the nonwoven sheet. The inventive nonwoven sheet may be used in various packaging configurations.

In still yet another embodiment of the first general embodiment, a method of packaging a medical device is described. This method comprises (1) providing a package with a hydraulically-formed nonwoven sheet with first non-cellulosic polymeric fibers in an amount of from about 5% to about 90% by weight of the nonwoven sheet in its dry state and second non-cellulosic polymeric fibers in an amount of from about 10% to about 95% by weight of the nonwoven sheet in its dry state; (2) placing a medical device in the package; (3) enclosing the medical device in the package by forming a continuous closing seal; and (4) introducing a sterilizing gas into the sealed package through the nonwoven sheet. The first non-cellulosic polymeric fibers of the nonwoven sheet have an average diameter less than about 3.5 micron, an average cut length less than about 3 millimeters and an average aspect ratio of about 400 to about 2000; and the second non-cellulosic polymeric fibers of the nonwoven sheet have an average diameter greater than about 3.5 micron and an average aspect ratio of about 400 to about 1000.

In another embodiment of the first general embodiment, a method of manufacturing a hydraulically formed nonwoven sheet is described. This method comprises the sequential steps of (1) adding materials to a hydropulper, (2) agitating the materials added to the hydropulper to form a furnish, (3) delivering the furnish from the hydropulper to holding means, (4) delivering the furnish from the holding means to a forming section to form a web, (5) dewatering the web on the forming section, (6) couching the web to deliver the web to a pressing section, (7) pressing the web, (8) delivering the web to a drying section and (9) drying the web. The materials added to the hydropulper comprise water, first non-cellulosic polymeric fibers in an amount of from about 5% to about 90% by weight of the nonwoven sheet in its dry state and second non-cellulosic polymeric fibers in an amount of from about 10% to about 95% by weight of the nonwoven sheet in its dry state. The first non-cellulosic polymeric fibers added to the hydropulper have an average diameter less than about 3.5 micron, an average cut length less than about 3 millimeters and an average aspect ratio of about 400 to about 2000; and the second non-cellulosic polymeric fibers added to the hydropulper have an average diameter greater than about 3.5 micron and an average aspect ratio of about 400 to about 1000. Additional fibers and materials may be added to the hydropulper. The manufactured nonwoven sheet may be mono-layer or multi-layer.

In a second general embodiment, a hydraulically-formed nonwoven sheet comprises (1) binding material in an amount of from about 5% to about 40% by weight of the nonwoven sheet in its dry state, (2) non-cellulosic polymeric fibers in an amount of from about 5% to about 40% by weight of the nonwoven sheet in its dry state and (3) cellulosic based materials in an amount of from about 45% to about 75% by weight of the nonwoven sheet in its dry state. The non-cellulosic polymeric fibers have an average diameter less than about 3.5 micron, an average cut length less than about 3 millimeters and an average aspect ratio of about 400 to about 2000; and the cellulosic based materials comprise (a) fibers manufactured from cellulose: (b) naturally occurring cellulosic materials selected from hardwood fibers, softwood fibers, non-wood fibers or blends thereof; or (c) blends of fibers manufactured from cellulose and naturally occurring cellulosic materials. This nonwoven sheet has a bacterial filtration efficiency of at least about 98%. Additional fibers and materials may be added to this nonwoven sheet. This inventive nonwoven sheet may be mono-layer or multi-layer.

### BRIEF DESCRIPTION OF THE DRAWINGS

FIG. 1 is a diagrammatic representation of various fiber shapes.

FIG. 2 is the chemical structure of polyethylene terephthalate.

FIG. 3 is the chemical structure of naturally occurring cellulose.

FIG. 4 is a schematic representation of a first embodiment of a stock preparation system for an apparatus for manufacturing a hydraulically-formed nonwoven sheet.

FIG. 5 is a schematic representation of a second embodiment of a stock preparation system for an apparatus for manufacturing a hydraulically-formed nonwoven sheet.

FIG. 6 is a diagrammatic representation of an apparatus for manufacturing a hydraulically-formed nonwoven sheet.

### DETAILED DESCRIPTION OF THE INVENTION

In a first general embodiment of the invention, a hydraulically-formed nonwoven sheet comprises first non-cellulosic polymeric fibers and second non-cellulosic polymeric fibers.

As used throughout this application, “hydraulically-formed” means formed with water. “Hydraulically-formed” is equivalent to “wet-laid” or “wet-formed.” In the wet-laid process, a nonwoven web is produced by filtering an aqueous suspension of fiber. The “hydraulically-formed” or “wet-laid” process is distinct from an air-laid process in which fibers are dispersed into a fast moving air stream and condensed onto a moving screen by means of pressure or vacuum. It is distinct from a carded or dry-laid process in which fibers are aligned either parallel or randomly in the direction that a carding machine produces the web. It is distinct from an electrostatically-laid process in which an electrostatic field from a polymer solution, polymer emulsion or polymer met is used to form a web. It is distinct from spunlaid processes (such as a flash spun process, a melt blown process, a melt spun process or a spunbond process) in which a polymeric melt of solution is extruded through spinnerets to form filaments which are laid down on a moving screen. It is distinct from a spunlaced or hydroentangling process in which fibers are interlocked and entangled by high velocity streams of water. (See INDA, Association of the Nonwovens Fabrics Industry, INDA Nonwovens Glossary, 2002, pp. 1-64 (INDA, Cary, N.C.), which is incorporated in its entirety in this application by this reference.)

As used throughout this application, “nonwoven” means not woven, knitted or felted.

As used throughout this application, “non-cellulosic polymeric fibers” means discrete polymeric fibers that are not cellulosic (as defined below). Suitable non-cellulosic polymeric fibers are typically (though not necessarily) synthetic fibers that are formed through the melt extrusion process, drawn and elongated, and cut to length and, as such, have a molecular weight and viscosity suitable for surviving this process.

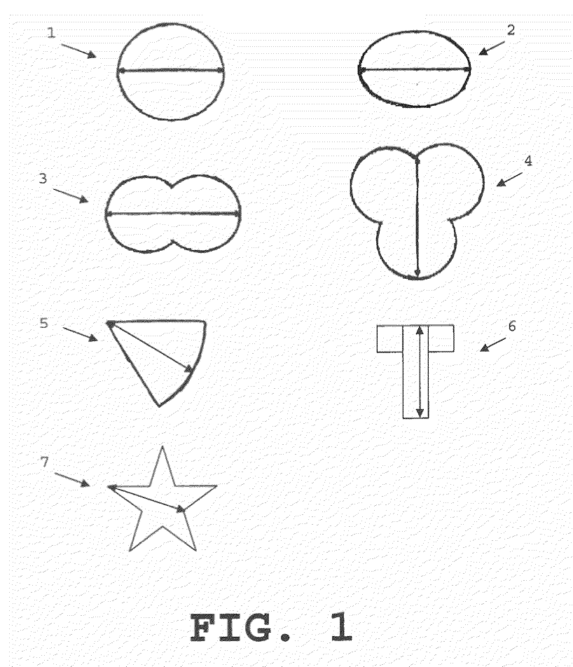

Non-cellulosic polymeric fibers may have non-flat, curved or multi-pointed cross-sections. Examples of such cross-sections include round, oval, bi-modal, tri-lobal, pie-shaped, T-shaped, star-shaped or other non-flat shapes with some curvature or points. FIG. 1 is a diagrammatic representation of various fiber cross-sections. FIG. 1 includes round cross-section 1, oval cross-section 2, bimodal cross-section 3, tri-lobal cross-section 4, pie-shaped cross-section 5, T-shaped cross-section 6 and star-shaped cross-section 7. The method for determining the diameter of the fiber depends on the cross-section. The arrows illustrate the dimension measured, for the purposes of this application, to determine the fiber diameter for the various cross-sections.

Fiber diameters may be measured in either micron or denier per filament. As used throughout this application, “denier per filament” (or dpf) means the denier of a fiber divided by its number of filaments. “Denier” means the weight in grams of 9,000 meters of fiber. It is a property that varies depending on the fiber type. The formula for converting dpf into micron is as follows:

Diameter in micron=11.89×(dpf/density in grams per millimeter)^{1/2}

Therefore, for example, the diameter in micron of a 3.0 dpf polyester fiber (with a density of 1.38 g/mL) is about 18 (as 11.89×(3/1.38)^{1/2} equals 17.53). (As used throughout this application, “about” means approximately, rounded up or down to, reasonably close to, in the vicinity of or the like.)

Microfibers, defined as fibers with a diameter of less than about 10 micron, may be formed through melt extruding, elongating and cutting via matrices such as “islands-in-the-sea, “side-by side,” “core/sheath” or “segmented pie.” (See US Patent Application 200810311815 Al, published Dec. 18, 2008, which is incorporated in its entirety in this application by this reference; see also Reese, “Polyesters, Fibers,” Encyclopedia of Polymer Science and Technology, Third Edition, 2003, Volume 3, pp. 652-678 (John Wiley & Sons, Inc., Hoboken, N.J.), which is incorporated in its entirety in this application by this reference,)

Non-cellulosic polymeric fibers as described throughout this application are typically (though not necessarily) thermoplastic. As thermoplastic materials, these polymers may be heated to an elevated temperature, shaped, set and then reheated, shaped and set again. Thermoplastic materials are distinct from thermoset materials, which cannot be reshaped by heating to an elevated temperature. Another classification of polymeric materials is crystalline versus amorphous. Crystalline polymers have a high level of symmetry and/or a relative simplicity of the polymer backbone and packing is encouraged. Amorphous polymers have an asymmetric monomer structure and/or contain bulky pendant groups and packing may be inhibited. (See Petherick, “Characterization of Polymers,” Encyclopedia of Polymer Science and Technology, Third Edition, 2004, Volume 9, pp. 159-188 (John Wiley & Sons, Inc., Hoboken, N.J.), which is incorporated in its entirety in this application by this reference.) It is contemplated that non-cellulosic polymeric fibers may comprise crystalline or amorphous polymers, polymers having varying percentages of crystalline or amorphous regions, or blends of crystalline, amorphous, partially crystalline or partially amorphous polymers. For example, polyamides that are predominantly crystalline or amorphous in nature are commercially available and use of such polymers is contemplated.

Non-cellulosic polymeric fibers may have a hydrophilic coating or preferably may have no coating.

Non-cellulosic polymeric fibers may be oriented. As used throughout this application, “oriented” means fibers (or materials) that are drawn and stretched at elevated temperatures and then annealed or “heat set” in the stretched configuration by cooling. Annealing or “heat-setting” imparts high-temperature stability, as the annealed drawn fibers then exhibit minimal shrinkage values when again exposed to elevated temperatures. The general annealing process by which materials are heated under controlled tension to reduce or eliminate shrinkage values is well known in the art. For the present invention, non-cellulosic polymeric fibers may be drawn or stretched in the machine direction in a ratio of from about 2:1 to about 6:1 or preferably of from about 3:1 to about 4:1 and then annealed to produce fibers with shrinkage values of less than 10% or preferably less than 5%. Based on the nature of the polymeric fibers and the desired properties, a person of ordinary skill in the art is able to determine the appropriate conditions and parameters for the orientation process for the non-cellulosic polymeric fibers.

The total weight of non-cellulosic polymeric fibers present in the first general embodiment of the hydraulically-formed nonwoven sheet is at least about 35% by the weight of the nonwoven sheet in its dry state, preferably at least about 50% by weight of the nonwoven sheet in its dry state or more preferably at least about 65% by weight of the nonwoven sheet in its dry state. As used throughout this application, “weight of the nonwoven sheet in its dry state” means the total weight of the materials that the nonwoven sheet comprises based on the weight of the materials when such materials are dry, i.e., when the materials have moisture regain of less than about 10%.

Non-cellulosic polymeric fibers of the first general embodiment include first non-cellulosic polymeric fibers and second non-cellulosic polymeric fibers and may include third non-cellulosic polymeric fibers and/or other non-cellulosic polymeric fibers or blends thereof.

As used throughout this application, first non-cellulosic polymeric fibers of the first general embodiment have an average diameter less than about 3.5 micron, an average cut length of less than about 3 millimeters and an average aspect ratio (i.e., ratio of length to diameter) of about 400 to about 2000. First non-cellulosic polymeric fibers are present in the first general embodiment of the hydraulically-formed nonwoven sheet in an amount of from about 5% to about 90% by weight of the nonwoven sheet in its dry state, preferably in an amount of from about 10% to about 50% by weight of the nonwoven sheet in its dry state or more preferably in an amount of from about 10% to 35% by weight of the nonwoven sheet in its dry state.

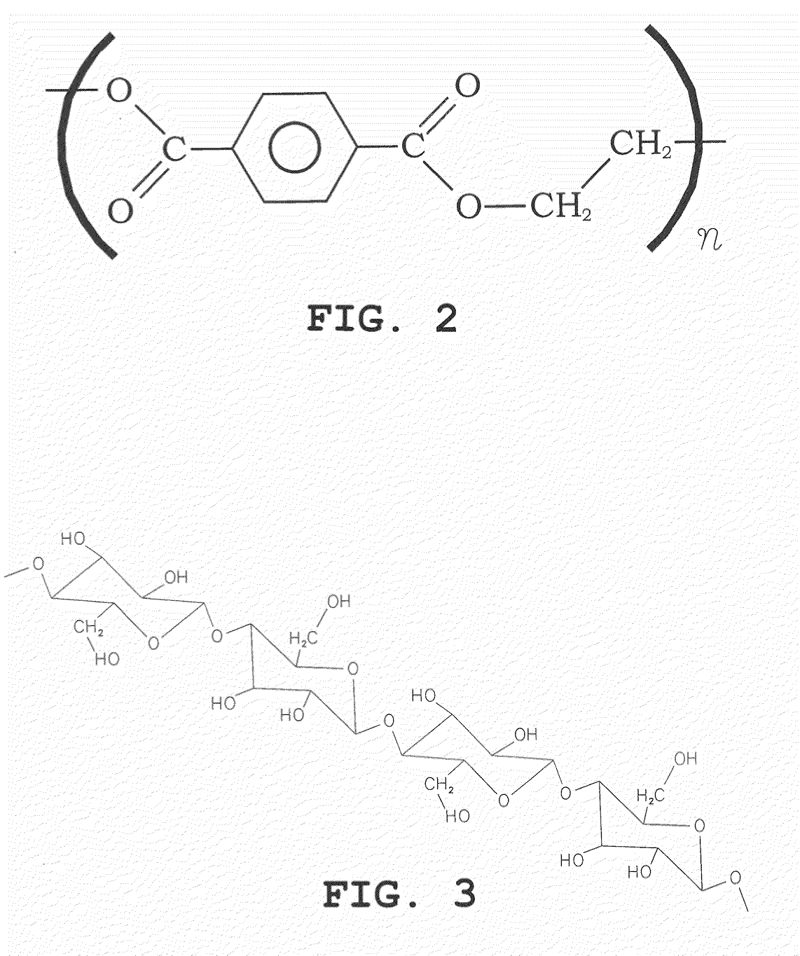

First non-cellulosic polymeric fibers may comprise polymers including homopolymers and copolymers of, for example, polyolefin, polyester, polyamide, polylactide, polycaprolactone, polycarbonate, polyurethane, polyvinyl acetate, polyvinyl chloride, polyvinyl alcohol, polyacrylate, polyacrylonitrile, ionomer or blends of these polymers. Examples of polyolefins include but are not limited to polyethylene, polypropylene, propylene-ethylene copolymers and ethylene a-olefin copolymers. An example of a polyester includes but is not limited to polyethylene terephthalate; FIG. 2 is the chemical structure of polyethylene terephthalate. An example of an ionomer includes but is not limited to Surlyn®, which is available from E.I. du Pont de Nemours and Company (Wilmington, Del.).

An example of first non-cellulosic polymeric fibers is E3164101 from Eastman Chemical Company (Kingsport, Tenn.). E3164101 is a polyester fiber as disclosed in US Patent Application 2008/0311815 A1, published Dec. 18, 2008, which is incorporated in its entirety in this application by this reference. E3164101 may be produced to have varying diameters and cut lengths, including but not limited to an average diameter of 2.5 micron and an average cut length of 1.5 millimeters.

As used throughout this application, second non-cellulosic polymeric fibers of the first general embodiment have an average diameter greater than about 3.5 micron and an average aspect ratio (i.e., ratio of average fiber length to average fiber diameter) of about 400 to about 1000. Second non-cellulosic polymeric fibers are present in the first general embodiment of the hydraulically-formed nonwoven sheet in an amount of from about 10% to about 95% by weight of the nonwoven sheet in its dry state, preferably in an amount of from about 20% to about 65% by weight of the nonwoven sheet in its dry state or more preferably in an amount of from about 25% to 65% by weight of the nonwoven sheet in its dry state.

Second non-cellulosic polymeric fibers may comprise polymers including homopolymers and copolymers of, for example, polyolefin, polyester, polyamide, polylactide. polycaprolactone, polycarbonate, polyurethane, polyvinyl acetate, polyvinyl chloride, polyvinyl alcohol, polyacrylate, polyacrylonitrile, ionomer or blends of these polymers. Examples of polyolefins include but are not limited to polyethylene, polypropylene, propylene-ethylene copolymers and ethylene a-olefin copolymers. An example of a polyester includes but is not limited to polyethylene terephthalate; FIG. 2 is the chemical structure of polyethylene terephthalate. An example of an ionomer includes but is not limited to Surlyn®, which is available from E.I. du Pont de Nemours and Company (Wilmington, Del.).

Examples of second non-cellulosic polymeric fibers are EP043 (a polyester fiber with a round cross-section, an average diameter of 0.5 denier per filament (dpf) (about 7 micron) and an average cut length of 3 or 5 millimeters), EP053 (a polyester fiber with a round cross-section, an average diameter of 0.8 dpf (about 9 micron) and an average cut length of 5 millimeters), EP133 (a polyester fiber with a round cross-section, an average diameter of 1.3 dpf (about 12 micron) and average cut length of 5, 6, 10 or 12 millimeters), EP203 (a polyester fiber with a round cross-section, an average diameter of 1.9 dpf (about 14 micron) and an average cut length of 5 or 10 millimeters), EPTC203 (a polyester fiber with a T-shaped cross-section, an average diameter of 2.2 dpf (about 20 micron) and an average cut length of 10 millimeters) and EP303 (a polyester fiber with a round cross-section, an average diameter of 2.8 dpf (about 17 micron) and an average cut length of 10 millimeters), all of which are produced by Kuraray Co., Ltd., and available from Engineered Fibers Technology (Longmeadow, Mass.).

Additional examples of second non-cellulosic polymeric fibers are various fibers available from Minifibers, Inc. (Johnson City, Tenn.). These Minifibers fibers include the following: Acrylic Fibers with an average diameter of 1.5 dpf (about 13 micron) and an average cut length of 6 or 12 millimeters; Acrylic Fibers with an average diameter of 3.0 dpf (about 19 micron) and an average cut length of 12 or 19 millimeters; Acrylic Fibers with an average diameter of 15.0 dpf (about 43 micron) and an average cut length of 19 or 25 millimeters; Bionelle/Biomax Aliphatic Polyester Bicomponent Fibers with an average diameter of 3.0 dpf (about 18 micron) and an average cut length of 10 millimeters; Bionelle/Biomax Aliphatic Polyester Bicomponent Fibers with an average diameter of 6.0 dpf (about 25 micron) and an average cut length of 10 millimeters; Bionelle Aliphatic Polyester/PolyLactic Acid Bicomponent Fibers with an average diameter of 3.0 dpf (about 18 micron) and an average cut length of 10 millimeters; Bionelle Aliphatic Polyester/PolyLactic Acid Bicomponent Fibers with an average diameter of 6.0 dpf (about 25 micron) and an average cut length of 10 millimeters; BC110 (Co-Polyester/Polyester Bicomponent Fibers) with an average diameter of 2.0 dpf (about 14 micron) and an average cut length of 6 or 12 millimeters; BC185 (Co-Polyester/Polyester Bicomponent Fibers) with an average diameter of 3.0 dpf (about 18 micron) and an average cut length of 12 millimeters; Ethyl Vinyl Acetate/Polypropylene Bicomponent Fibers with an average diameter of 2.0 dpf (about 18 micron) and an average cut length of 10 millimeters; Ethyl Vinyl Acetate/Polypropylene Bicomponent Fibers with an average diameter of 3.0 dpf (about 22 micron) and an average cut length of 10 millimeters; Ethyl Vinyl Alcohol/Polypropylene Concentric Bicomponent Fibers with an average diameter of 2.0 dpf (about 16 micron) and an average cut length of 10 millimeters; High Density Polyethylene/Polyester Bicomponent Fibers with an average diameter of 2.0 dpf (about 16 micron) and an average cut length of 10 millimeters; High Density Polyethylene/Polyester Bicomponent Fibers with an average diameter of 6.0 dpf (about 27 micron) and an average cut length of 10 millimeters; High Density Polyethylene/Polypropylene Bicomponent Fibers with an average diameter of 0.7 dpf (about 10 micron) and an average cut length of 5 or 10 millimeters; High Density Polyethylene/Polypropylene Bicomponent Fibers with an average diameter of 2.5 dpf (about 19 micron) and an average cut length of 10 millimeters; Nomex® Aramid Fibers with an average diameter of 2.0 dpf (about 14 micron) and an average cut length of 6 or 12 millimeters; Type 6,6 Regular Tenacity Nylon Fibers with an average diameter of 1.0 dpf (about 11 micron) and an average cut length of 6 or 9 millimeters; Type 6,6 Regular Tenacity Nylon Fibers with an average diameter of 3.0 dpf (about 19 micron) and an average cut length of 12 or 19 millimeters; Type 6,6 Regular Tenacity Nylon Fibers with an average diameter of 6.0 dpf (about 27 micron) and an average cut length of 12, 19 or 25 millimeters; Type 6,6 High Tenacity Bright Nylon Fibers with an average diameter of 6.0 dpf (about 27 micron) and an average cut length of 12, 19 or 25 millimeters; Multicolor BCF Nylon Fibers with an average diameter of 12.0 dpf (about 39 micron) and an average cut length of 19 or 25 millimeters; Type 6 Nylon Fibers with an average diameter of 3.0 dpf (about 19 micron) and an average cut length of 12 or 19 millimeters; Regular Shrink, Regular Tenacity Polyester Fibers with an average diameter of 3.0 dpf (about 18 micron) and an average cut length of 12 millimeters; Regular Shrink, Regular Tenacity Polyester Fibers with an average diameter of 1.5 dpf (about 12 micron) and an average cut length of 6 or 12 millimeters; Regular Shrink, Regular Tenacity Polyester Fibers with an average diameter of 1.0 dpf (about 10 micron) and an average cut length of 6 millimeters; Regular Shrink, Regular Tenacity Polyester Fibers with an average diameter of 0.7 dpf (about 8 micron) and an average cut length of 3 or 6 millimeters; Regular Shrink, Regular Tenacity Polyester Fibers with an average diameter of 0.5 dpf (about 7 micron) and an average cut length of 3 or 6 millimeters; Regular Shrink, Regular Tenacity Black Polyester Fibers with an average diameter of 3.0 dpf (about 18 micron) and an average cut length of 12 millimeters; Trilobal Polyester Fibers with an average diameter of 3.0 dpf (about 18 micron) and an average cut length of 12 millimeters; Regular Shrink, High Tenacity Polyester Fibers with an average diameter of 12.0 dpf (about 35 micron) and an average cut length of 19 or 25 millimeters; Regular Shrink, High Tenacity Polyester Fibers with an average diameter of 6.0 dpf (about 25 micron) and an average cut length of 12, 19 or 25 millimeters; Regular Shrink, High Tenacity Polyester Fibers with an average diameter of 3.0 dpf (about 18 micron) and an average cut length of 12 millimeters; Low Shrink, High Tenacity Bright Polyester Fibers with an average diameter of 6.0 dpf (about 25 micron) and an average cut length of 12, 19 or 25 millimeters; Low Shrink, High Tenacity Bright Polyester Fibers with an average diameter of 3.0 dpf (about 18 micron) and an average cut length of 12 millimeters; Biodegradable LLDPE Polyethylene Fibers with an average diameter of 5.0 dpf (about 27 micron) and an average cut length of 12, 19 or 25 millimeters; Low-Melt LLDPE Polyethylene Fibers with an average diameter of 6.0 dpf (about 30 micron) and an average cut length of 12, 19 or 25 millimeters; PolyLactic Acid (PLA) Fibers with an average diameter of 1.3 dpf (about 12 micron) and an average cut length of 6 or 12 millimeters; Polypropylene Fibers with an average diameter of 0.7dpf (about 10 micron) and an average cut length of 5 or 10 millimeters; Polypropylene Fibers with an average diameter of 3.0 dpf (about 22 micron) and an average cut length of 12 millimeters; Polypropylene Fibers with an average diameter of 7.0 dpf (about 33 micron) and an average cut length of 12, 19 or 25 millimeters; Multicolor Polypropylene Fibers with an average diameter of 12.0 dpf (about 43 micron) and an average cut length of 19 or 25 millimeters; and Multicolor Polypropylene Fibers with an average diameter of 15.0 dpf (about 48 micron) and an average cut length of 19 or 25 millimeters.

The first general embodiment of the hydraulically-formed nonwoven sheet may also comprise third non-cellulosic polymeric fibers. As used throughout this application, third non-cellulosic polymeric fibers of the first general embodiment have an average diameter greater than about 10 micron and an average cut length greater than about 5 millimeters. Third non-cellulosic polymeric fibers may be present in the first general embodiment of the hydraulically-formed nonwoven sheet in an amount of from 0% to about 50% by weight of the nonwoven sheet in its dry state, preferably in an amount of from about 5% to about 30% by weight of the nonwoven sheet in its dry state or more preferably in an amount of from about 5% to 20% by weight of the nonwoven sheet in its dry state.

Third non-cellulosic polymeric fibers may comprise polymers including homopolymers and copolymers of, for example, polyolefin, polyester, polyamide, polylactide, polycaprolactone, polycarbonate, polyurethane, polyvinyl acetate, polyvinyl chloride, polyvinyl alcohol, polyacrylate, polyacrylonitrile, ionomer or blends of these polymers. Examples of polyolefins include but are not limited to polyethylene, polypropylene, propylene-ethylene copolymers and ethylene a-olefin copolymers. An example of a polyester includes but is not limited to polyethylene terephthalate; FIG. 2 is the chemical structure of polyethylene terephthalate. An example of an ionomer includes but is not limited to Surlyn®, which is available from E.I. du Pont de Nemours and Company (Wilmington, Del.).

Examples of third non-cellulosic polymeric fibers are EP133 (a polyester fiber with a round cross-section, an average diameter of 1.3 denier (about 12 micron) and average cut length of 5, 6, 10, 12 or 15 millimeters), EP203 (a polyester fiber with a round cross-section, an average diameter of 1.9 denier (about 14 micron) and an average cut length of 5 or 10 millimeters), EPTC203 (a polyester fiber with a T-shaped cross-section, an average diameter of 2.2 dpf (about 20 micron) and an average cut length of 5 or 10 millimeters) and EP303 (a polyester fiber with a round cross-section, an average diameter of 2.8 denier (about 17 micron) and an average cut length of 5 or 10 millimeters), all or which are produced by Kuraray Co., Ltd., and available from Engineered Fibers Technology (Longmeadow, Mass.).

Additional examples of third non-cellulosic polymeric fibers are various fibers available from Minifibers, Inc. (Johnson City, Tenn.). These Minifibers fibers include the following: Acrylic Fibers with an average diameter of 15.0 dpf (about 43 micron) and an average cut length of 6, 12, 19 or 25 millimeters; Acrylic Fibers with an average diameter of 3.0 dpf (about 19 micron) and an average cut length of 6, 12, 19 or 25 millimeters; Acrylic Fibers with an average diameter of 1.5 dpf (about 13 micron) and an average cut length of 6, 12, 19 or 25 millimeters; Bionelle/Biomax Aliphatic Polyester Bicomponent Fibers with an average diameter of 6.0 dpf (about 25 micron) and an average cut length of 5 or 10 millimeters; Bionelle/Biomax Aliphatic Polyester Bicomponent Fibers with an average diameter of 3.0 dpf (about 18 micron) and an average cut length of 5 or 10 millimeters; Bionelle Aliphatic Polyester/PolyLactic Acid Bicomponent Fibers with an average diameter of 6.0 dpf (about 25 micron) and an average cut length of 5 or 10 millimeters; Bionelle Aliphatic Polyester/PolyLactic Acid Bicomponent Fibers with an average diameter of 3.0 dpf (about 18 micron) and an average cut length of 5 or 10 millimeters; BC110 (Co-Polyester/Polyester Bicomponent Fibers) with an average diameter of 2.0 dpf (about 14 micron) and an average cut length of 6, 12, 19 or 25 millimeters; BC185 (Co-Polyester/Polyester Bicomponent Fibers) with an average diameter of 3.0 dpf (about 18 micron) and an average cut length of 6, 12, 19 or 25 millimeters; Co-Polypropylene/Polypropylene Bicomponent Fibers with an average diameter of 2.0 dpf (about 18 micron) and an average cut length of 5 millimeters; Ethyl Vinyl Acetate/Polypropylene Bicomponent Fibers with an average diameter of 2.0 dpf (about 18 micron) and an average cut length of 5 or 10 millimeters; Ethyl Vinyl Acetate/Polypropylene Bicomponent Fibers with an average diameter of 3.0 dpf (about 22 micron) and an average cut length of 5 or 10 millimeters; Ethyl Vinyl Alcohol/Polypropylene Concentric Bicomponent Fibers with an average diameter of 2.0 dpf (about 16 micron) and an average cut length of 5 or 10 millimeters; Ethyl Vinyl Alcohol/Polypropylene Splittable Bicomponent Fibers with an average diameter of 3.0 dpf (about 20 micron) and an average cut length of 6 millimeters; High Density Polyethylene/Polyester Bicomponent Fibers with an average diameter of 6.0 dpf (about 27 micron) and an average cut length of 5 or 10 millimeters; High Density Polyethylene/Polyester Bicomponent Fibers with an average diameter of 2.0 (about 16 micron) and an average cut length of 5 or 10 millimeters; High Density Polyethylene/Polypropylene Bicomponent Fibers with an average diameter of 2.5 dpf (about 19 micron) and an average cut length of 5 millimeters; High Density Polyethylene/Polypropylene Bicomponent Fibers with an average diameter of 0.7 dpf (about 10 micron) and an average cut length of 5 or 10 millimeters; PolyLactic Acid/PolyLactic Acid Bicomponent Fibers with an average diameter of 4.0 dpf (about 21 micron) and an average cut length of 51 millimeters; PolyLactic Acid/PolyLactic Acid Bicomponent Fibers with an average diameter of 6.0 dpf (about 26 micron) and an average cut length of 51 millimeters; Nomex® Aramid Fibers with an average diameter of 2.0 dpf (about 14 micron) and an average cut length of 6, 12, 19 or 25 millimeters; Type 6,6 Regular Tenacity Nylon Fibers with an average diameter of 6.0 dpf (about 27 micron) and an average cut length of 6, 9, 12, 19 or 25 millimeters; Type 6,6 Regular Tenacity Nylon Fibers with an average diameter of 3.0 dpf (about 19 micron) and an average cut length of 6, 9, 12, 19 or 25 millimeters; Type 6,6 Regular Tenacity Nylon Fibers with an average diameter of 1.0 dpf (about 11 micron) and an average cut length of 6, 9, 12, 19 or 25 millimeters; Type 6,6 High Tenacity Bright Nylon Fibers with an average diameter of 6.0 dpf (about 27 micron) and an average cut length of 6, 12, 19, 25 millimeters; Multicolor BCF Nylon Fibers with an average diameter of 12.0 dpf (about 39 micron) and an average cut length of 6, 12, 19 or 25 millimeters; Type 6 Nylon Fibers with an average diameter of 3.0 dpf (about 19 micron) and an average cut length of 6, 12, 19 or 25 millimeters; Regular Shrink, Regular Tenacity Polyester Fibers with an average diameter of 1.0 dpf (about 10 micron) and an average cut length of 6,12, 19 or 25 millimeters; Regular Shrink, Regular Tenacity Polyester Fibers with an average diameter of 1.5 dpf (about 12 micron) and an average cut length of 6, 12, 19 or 25 millimeters; Regular Shrink, Regular Tenacity Polyester Fibers with an average diameter of 3.0 dpf (about 18 micron) and an average cut length of 6, 12, 19 or 25 millimeters; Regular Shrink, Regular Tenacity Black Polyester Fibers with an average diameter of 3.0 dpf (about 18 micron) and an average cut length of 6, 12, 19 or 25 millimeters; Trilobal Polyester Fibers with an average diameter of 3.0 dpf (about 18 micron) and an average cut length of 6, 12, 19 or 25 millimeters; Regular Shrink, High Tenacity Polyester Fibers with an average diameter of 3,0 dpf (about 18 micron) and an average cut length of 6, 12, 19 or 25 millimeters; Regular Shrink, High Tenacity Polyester Fibers with an average diameter of 6.0 dpf (about 25 micron) and an average cut length of 6, 12, 19 or 25 millimeters; Regular Shrink, High Tenacity Polyester Fibers with an average diameter of 12.0 dpf (about 35 micron) and an average cut length of 6, 12, 19 or 25 millimeters; Low Shrink, High Tenacity Bright Polyester Fibers with an average diameter of 3.0 dpf (about 18 micron) and an average cut length of 6, 12, 19 or 25 millimeters; Low Shrink, High Tenacity Bright Polyester Fibers with an average diameter of 6.0 dpf (about 25 micron) and an average cut length of 6, 12, 19 or 25 millimeters; Biodegradable LLDPE Polyethylene Fibers with an average diameter of 5.0 dpf (about 27 micron) and an average cut length of 6, 12, 19 or 25 millimeters: Low-Melt LLDPE Polyethylene Fibers with an average diameter of 6.0 dpf (about 30 micron) and an average cut length of 6, 12, 19 or25 millimeters: PolyLactic Acid (PLA) Fibers with an average diameter of 1.3 dpf (about 12 micron) and an average cut length of 6, 12, 19 or 25 millimeters; Polypropylene Fibers with an average diameter of 0.7 dpf (about 10 micron) and an average cut length of 5 or 10 millimeters; Polypropylene Fibers with an average diameter of 3.0 dpf (about 22 micron) and an average cut length of 6 or 12 millimeters; Polypropylene Fibers with an average diameter of 7.0 dpf (about 33 micron) and an average cut length of 6, 12, 19 or 25 millimeters; Multicolor Polypropylene Fibers with an average diameter of 12.0 dpf (about 43 micron) and an average cut length of 6, 12, 19 or 25 millimeters; and Multicolor Polypropylene Fibers with an average diameter of 15.0 dpf (about 48 micron) and an average cut length of 6, 12, 19 or 25 millimeters.

The first general embodiment of the hydraulically-formed nonwoven sheet may also comprise cellulosic based materials. Cellulosic based materials may be present in the first general embodiment of the hydraulically-formed nonwoven sheet in an amount of from 0% to about 75% by weight of the nonwoven sheet in its dry state, preferably in an amount of from about 5% to about 35% by weight of the nonwoven sheet in its dry state or more preferably in an amount of from about 5% to 20% by weight of the nonwoven sheet in its dry state. As used throughout this application, cellulosic based materials include naturally occurring cellulosic materials, fibers manufactured from cellulose or both.

Naturally occurring cellulosic materials occur, with limited exception, as the result of biosynthesis. The chemical structure of naturally occurring cellulose is relatively simple. FIG. 3 is the chemical structure of naturally occurring cellulose. The simplicity of the structure lies in the repetition of the anyhydroglucose unit C₆H₁₀O₅ as the building block. The term “cellulose” does not mean any specific chemical or homogenous substance but refers to the homologous series of compounds having a specific (1→4) β (diequatorial) linkage between each anhydroglucose unit.

Naturally occurring cellulosic materials include hardwood fibers, softwood fibers and non-wood fibers. Harwood fibers are those from hardwood trees; hardwood trees are angiosperms and deciduous and include but are not limited to acacia, ash, balsa, basswood, beech, birch, cherry, cottonwood, elm, eucalyptus, hickory, mahogany, maple, oak, poplar, rosewood, sumac, sycamore and walnut. A further example of hardwood fiber is bleached eucalyptus pulp, which is available from Aracruz Cellulose S.A. (Säo Paulo, Brazil). Softwood fibers are those from softwood trees; softwood trees are gymnosperms and deciduous and include but are not limited to cedar, fir, hemlock, pine, redwood and spruce. A further example of softwood fiber is Hinton Hibrite NBSK Pulp (comprising about 5% interior fir (balsam), 20% spruce and 75% lodgepole pine), which is available from Wet Fraser Timber Co. Ltd. (Vancouver, British Columbia, Canada). (See Bond, et al., “Wood Identification for Hardwood and Softwood Species Native to Tenn.,” 2005 (PB1692, www.utextension.utk.edu/publications/pbfiles/pb1692.pdf, Agricultural Extension Service, The University of Tennessee—Knoxville, Knoxville, Tenn.), which is incorporated in its entirety in this application by this reference.)

Non-wood naturally occurring cellulosic materials include those from hairs on seeds, such as cotton, kapok and milkweed; those from stems of plants, such as bagasse, bamboo, flax, hemp, jute, kenaf and ramie; those from leaves of plants, such as agave, banana and pineapple; those from the stalks and leaves of maize, those from algae (algal cellulose), those from bacteria (bacterial cellulose), those from sugar beet pulp and those from citrus pulp. A further example of non-wood fiber is currency cotton or rag stock, which is available from Buckeye Technologies Inc. (Memphis, Tenn.). (See, French, et al., “Cellulose” Encyclopedia of Polymer Science and Technology, Third Edition, 2003, Volume 5, pp. 473-507 (John Wiley & Sons, Inc., Hoboken, N.J.), which is incorporated in its entirety in this application by this reference.)

In contrast to naturally occurring cellulosic materials are fibers manufactured from cellulose. Fibers manufactured from cellulose are either derivative or regenerated.

Derivative fibers are fibers formed when a chemical derivative of a naturally occurring cellulosic material is prepared, dissolved and extruded as a continuous filament, and the chemical nature of the derivative is retained after the fiber formation process. For example, derivitization of cellulose as esters and/or ethers modifies the solubility profile of the cellulosic material while maintaining many of its polymeric properties.

Cellulose esters can be either inorganic or organic. Inorganic esters of cellulose include all esters where the atoms linked directly to the cellulosic oxygens are non-carbon. Examples of inorganic cellulose esters include but are not limited to cellulose nitrate, cellulose sulfate, cellulose sulfonate, cellulose deoxysulfonate and cellulose phosphate. (See Shelton, “Cellulose Esters, Inorganic” Encyclopedia of Polymer Science and Technology, Third Edition, 2004, Volume 9, pp. 113-129 (John Wiley & Sons, Inc., Hoboken, N.J.), which is incorporated in its entirety in this application by this reference.) Organic esters of cellulose are commonly derived from natural cellulose by reaction with organic acids, anhydrides or acid chlorides. Examples of organic cellulose esters include but are not limited to cellulose acetate, cellulose acetate phthalate, cellulose acetate butyrate, cellulose triacetate, cellulose formate, cellulose propionate, cellulose butyrate, cellulose acetate valerate, cellulose propionate valerate, cellulose butyrate valerate, cellulose acetate isobutyrate, cellulose propionate isobutyrate and cellulose diacetate. A further example of an organic cellulose ester is Estron acetate yarn, which is available from Eastman Chemical Company (Kingsport, Tenn.). (See Edgar, “Cellulose Esters, Organic” Encyclopedia of Polymer Science and Technology, Third Edition, 2004, Volume 9, pp.129-158 (John Wiley & Sons, Inc., Hoboken, N.J.), which is incorporated in its entirety in this application by this reference.)

Cellulose ethers are manufactured by reaction of purified cellulose with alkylating reagents under heterogeneous conditions, usually in the presence of a base (e.g., sodium hydroxide) and an inert diluent. Examples of cellulose ethers include but are not limited to sodium carboxymethylcellulose, hydroxyethylcellulose, sodium carboxymethylhydroxyethylcellulose, ethylhydroxyethylcellulose, methylcellulose, hydroxypropylmethylcellulose, hydroxyethylmethylcellulose, hydroxybutylmethylcellulose, ethyl cellulose and hydroxypropylcellulose. (See Majewicz, et al., “Cellulose Ethers” Encyclopedia of Polymer Science and Technology, Third Edition, 2003, Volume 5, pp. 507-532 (John Wiley & Sons, Inc., Hoboken, N.J.), which is incorporated in its entirety in this application by this reference.)

Regenerated fibers are fibers formed when naturally occurring cellulosic material or its chemical derivative or complex is dissolved and extruded, and the chemical nature of the naturally occurring cellulosic material is retained or regenerated after the fiber formation process. (See Woodings, “Cellulose Fibers, Regenerated,” Encyclopedia of Polymer Science and Technology, Third Edition, 2003, Volume 5, pp. 532-569 (John Wiley & Sons, Inc., Hoboken, N.J.), which is incorporated in its entirety in this application by this reference: see also United States Statutory Invention Registration H1592, published Sep. 3, 1996, which is incorporated in its entirety in this application by this reference; see also Borbély, “Lyocell, The New Generation of Regenerated Cellulose, Acta Polytechnica Hungarica, Volume 5, Number 3, 2008, pp. 11-18, which is incorporated in its entirety in this application by this reference.)

The viscose process involves the dissolution and extrusion of a chemical derivative of cellulose (i.e., cellulose xanthate) to manufacture a fiber which is regenerated into cellulose. The regenerated cellulose fibers produced by the viscose process are generally known as rayon, including but not limited to regular rayon, improved rayon, modal rayon, polynosic rayon, alloy rayon and y-shaped rayon. Examples of rayon are Regular Tenacity Flocking Tow Rayon Fibers with average diameters of 0.8 dpf (about 9 micron), 1.5 dpf (about 12 micron), 3.0 dpf (about 17 micron), 4.5 dpf (about 20 micron) or 25 dpf (about 48 micron), any of which may have an average cut length of 2, 3, 6, 12, 19 or 25 millimeters; and High Tenacity Tire Cord Rayon Fibers with an average diameter of 1.5 dpf (about 12 micron) and an average cut length of 2, 3, 6, 12, 19 or 25 millimeters. Both of these example rayon fibers are available from Minifibers, Inc. (Johnson City, Tenn.).

The cuprammonium process involves the dissolution and extrusion of a chemical complex of cellulose (i.e., cuprammonium) to manufacture a regenerated fiber. The regenerated fibers produced by the cuprammonium process are generally known as cuprammonium rayon. An example of cuprammonium rayon is Bemberg™, which is available from Asahi Kasei Corporation (Tokyo, Japan).

The lyocell process involves the direct dissolution of naturally occurring cellulosic material in organic solvents; an example of a lyocell process is the Courtalds Lyocell process, also known as the Acordis Tencel process. The lyocell process generally involves the dissolution of naturally occurring cellulosic materials in an N-methyl morpholine-n-oxide solvent. The regenerated fibers manufactured from this process are generally known as lyocell fibers. An example of lyocell is Tencel®, which is available from Lenzing Fibers, Inc. (New York, N.Y.). Lyocell has a tendency to fibrillate. (As used throughout this application, “fibrillate” means develop micro-fibrils or nano-fibrils on the surface of the fiber.) Examples of nano-fibrillated lyocell are EFTec™ Nanofibrillated Fiber grades L200-6, L040-6, L010-6, L200-4, L040-4 and L010-4, all of which are available from Engineered Fibers Technology (Longmeadow, Mass.).

The first general embodiment of the hydraulically-formed nonwoven sheet may also comprise binding material. Binding material comprises acrylic latex (such as styrene butadiene copolymer or butadiene acrylonitrile copolymer), polyurethane, polyvinyl acetate, polyvinyl alcohol, natural rubber or other nature-based adhesive, polyvinyl chloride, polychloroprene, epoxy, phenol, urea-formaldehyde, thermal melt adhesive, surface treatment material, surface treatment method, binder fiber, crosslinking agent, tackifier or blends of such. Binding material may be present in the first general embodiment of the hydraulically-formed nonwoven sheet in an amount of from 0% to about 40% by weight of the nonwoven sheet in its dry state, preferably in an amount of from about 5% to about 40% by weight of the nonwoven sheet in its dry state or more preferably in an amount of from about 5% to 30% by weight of the nonwoven sheet in its dry state.

As used throughout this application, binding material includes materials and methods for resin bonding, thermal bonding, mechanical bonding and surface treatment. Resin bonding is bonding by chemical agents, including solvents and adhesive resins. Thermal bonding is bonding by activating a heat-sensitive material with heat or ultrasonic treatment, with or without pressure. Mechanical bonding is bonding by entangling by needling, stitching or otherwise. Surface treatment is bonding by altering the surface region. Binding material may be continuous and applied all over the sheet (e.g., through or area bonding) or may be discontinuous and restricted to pre-determined, discrete sties (e.g., point bonding or print bonding). (See INDA, Association of the Nonwovens Fabrics Industry, INDA Nonwovens Glossary, 2002, pp. 1-64 (INDA, Cary, N.C.), which is incorporated in its entirety in this application by this reference.)

In addition to binding the hydraulically-formed nonwoven sheet, binding material may also be added to reduce and/or eliminate Tinting of the non-woven sheet. As used throughout this application, “linting,” also known as fiber tear, relates to fibers or other particles from a hydraulically-formed nonwoven sheet detaching and depositing on articles packaged within a package comprising the hydraulically-formed nonwoven sheet.

Binding materials for resin bonding include solution adhesives, which are solvent-based solution adhesives or water-based solution adhesives. Solvent-based solution adhesives include but are not limited to contact adhesives (such as polychloroprenes), activatable dry-film adhesives (such as solvent-applied natural rubber) and solvent-weld adhesives (such as polyvinyl chloride). Water-based solution adhesives include but are not limited to polyurethanes, polyvinyl alcohol, polyvinyl acetate and polychloroprene latex adhesives. Binding materials for resin bonding also include structural adhesives such as epoxies, acrylics (including redox-activated adhesives, encompassing both anaerobic acrylics and nonaerobic structural acrylics, and polycyanoacrylates), urethanes, phenolics and urea-formaldehyde and related adhesives. Binding materials for resin bonding further include adhesives made from natural products such as protein-based adhesives, carbohydrate-based adhesives and other nature-based adhesives. (See Yorkgitis, “Adhesive Compounds,” Encyclopedia of Polymer Science and Technology, Third Edition, 2003, Volume 1, pp. 256-290 (John Wiley & Sons, Inc., Hoboken, N.J.), which is incorporated in its entirety in this application by this reference.)

Examples of binding materials for resin bonding are Rhoplex® B-15J (an acrylic latex binding material available from Rohm and Haas Chemicals, LLC, Philadelphia, Pa.), Hycar® 26469 (an acrylic latex binding material available from The Lubrizol Corporation, Wickliffe, Ohio), Revacryl 705 (an acrylic latex binding material available from Synthomer, LLC, Powell, Ohio), Latex DL 275NA (a styrene-butadiene copolymer binding material available from Dow Chemical Company, Midland, Mich.), Synthomer 50B30 (a styrene-butadiene copolymer binding material available from Synthomer, LLC, Powell, Ohio), Synthomer 7100 (a butadiene-acrylonitrile copolymer binding material available from Synthomer, LLC), RU-21-074 (a polyurethane binding material available from Stahl USA, Peabody. Mass.), RU-41-162 (a polyurethane binding material available from Stahl USA, Peabody, Mass.), RU-41-773 (a polyurethane binding material available from Stahl USA, Peabody, Mass.), Airflex® 920 Emulsion (a polyvinyl acetate binding material available from Air Products Polymers, L.P., Allentown, Pa.).

Binding materials for resin bonding also include crosslinking agents. Crosslinking agents are substances that promote or regulate intermolecular covalent bonding between polymers. Crosslinking agents may increase the heat resistance, improve the solvent resistance and/or increase the film forming temperature of polymers. Examples of crosslinking agents are ChemCor ZAC (a zinc ammonium carbonate ionic crosslinking agent), which is available from ChemCor (Chester, N.Y.); XR-5577 (a polycarbodiimide crosslinking agent), which is available from Stahl USA (Peabody, Mass.): and XR-5580 (a polycarbodiimide crosslinking agent), which is available from Stahl USA (Peabody, Mass.).

Binding materials for resin bonding also include tackifiers. Tackifiers may impart or control one or more of the following properties of one or more binding materials: tack, peel strength, cohesive strength, staining, migration or bleed through, stringing or legging and aging characteristics. Examples of tackifiers include but are not limited to petroleum-based aliphatics, petroleum aromatics, terpenes, rosin esters, pure monomer aromatics, α-pinene, low molecular weight polystyrene and copolymers of α-methyl-styrene-vinyl toluene. (See Benedek, “Manufacture of Pressure-Sensitive Adhesives,” Pressure-Sensitive Adhesives and Applications, Second Edition Revised, 2004, Chapter 8, pp. 425-557 (CRC Press, Boca Raton, Fla.), which is incorporated in its entirety in this application by this reference.)

Binding materials for resin bonding may be blended. For example, the binding material may be a blend of styrene butadiene copolymer, polyurethane and crosslinking agent. The binding material may be a blend of polyvinyl acetate, polyurethane and crosslinking agent.

Binding materials for,resin bonding with different stiffness characteristics (e.g., 100% modulus, elongation percent, glass transition temperature, etc.) may be blended to enhance the bond. For example, RU-41-162 (a polyurethane binding material available from Stahl USA. Peabody, Massachusetts), with a 100% modulus of 1500 pounds force per square inch and an elongation of 400%, may be blended with RU-41-773 (a polyurethane binding material available from Stahl USA, Peabody, Mass.), with a 100% modulus of 800 pounds force per square inch and an elongation of 710%. The binding material with the lower 100% modulus contributes to melt and flow while the binding material with the higher 100% modulus contributes to solidification.

Thermal bonding involves the addition of heat-sensitive (e.g., meltable) fibers and/or other materials as binding material for the hydraulically-formed nonwoven sheet. These binder fibers and/or other materials are generally thermoplastic and may be activated (e.g., melted) by treatment (e.g., heating) during drying, during calendering or otherwise. For example, if the activation step can be combined with the drying step, the heat-sensitive materials can be an efficient and cost effective binding material, as some binder fibers swell and partially dissolve when the nonwoven sheet reaches temperatures of from about 40° C. to about 90° C. in the drying section. Examples of heat-sensitive, binder fibers include but are not limited to polyvinyl chloride, polypropylene, polyethylene, cellulose acetate, polyester, polyvinyl alcohol and polyamide. (See Dahiya, et al., “Wet-Laid Nonwovens,” 2004 (http://www.engr.utk.edu/mse/pages/Textiles/Wet%20Laid%20Nonwovens.htm, Department of Materials Science and Engineering, The University of Tenn.—Knoxville, Knoxville, Tenn.), which is incorporated in its entirety in this application by this reference.)

Further examples of heat-sensitive, binder fibers are N720 (a bicomponent fiber with a co-polyester/polyester cross-section, an average diameter of 2.0 denier (about 14 micron) and an average cut length of 5 or 10 millimeters), N720H (a bicomponent fiber with a co-polyester/polyester cross-section, an average diameter of 2.1 denier (about 15 micron) and an average cut length of 5 millimeters), N721 (a bicomponent fiber with a co-polyester/polyester cross-section, an average diameter of 1.5 denier (about 13 micron) and an average cut length of 5 millimeters) and N700 (a bicomponent fiber with a co-polyester/polyester cross-section, an average diameter of 5.1 denier (about 23 micron) and an average cut length of 5 millimeters), all or which are produced by Kuraray Co., Ltd., and available from Engineered Fibers Technology (Longmeadow, Mass.).

Additional examples of heat-sensitive, binder fibers are various fibers available from Minifibers, Inc. (Johnson City, Tenn.). These Minifibers fibers include the following: E400 Fybrel® Synthetic Fiber with an average diameter of about 15 micron and an average cut length of 0.9 millimeters; E620 Fybrel® Synthetic Fiber with an average diameter of about 15 micron and an average cut length of 1.3 millimeters; Binder Fiber Polypropylene Fibers with an average diameter of 2.0 dpf (about 17 micron) and an average cut length of 5 millimeters; Bionelle/Biomax Aliphatic Polyester Bicomponent Fibers with an average diameter of 3.0 dpf (about 18 micron) and an average cut length of 2, 5 or 10 millimeters; Bionelle/Biomax Aliphatic Polyester Bicomponent Fibers with an average diameter of 6.0 dpf (about 25 micron) and an average cut length of 2, 5 or 10 millimeters; BC110 (Co-Polyester/Polyester Bicomponent Fibers) with an average diameter of 2.0 dpf (about 14 micron) and an average cut length of 3, 6, 12, 19 or 25 millimeters; BC185 (Co-Polyester/Polyester Bicomponent Fibers) with an average diameter of 3.0 dpf (about 18 micron) and an average cut length of 3, 6, 12, 19 or25 millimeters; and Low-Melt LLDPE Polyethylene Fibers with an average diameter of 6.0 dpf (about 30 micron) and an average cut length of 2, 3, 6, 12, 19 or 25 millimeters.

Surface treatment materials and methods bind the hydraulically-formed nonwoven sheet by altering the surfaces of the fibers and/or other materials in the nonwoven sheet. Methods of altering the surfaces include but are not limited to removing a weak boundary layer, changing surface topography, changing the chemical nature of the surface and modifying the physical structure of the surface. For example, the fibers and/or other materials may be liquid cleaned to remove any undesirable (e.g., hydrophobic) coating or other contamination. The fibers and/or other materials may also or alternatively be exposed to a corona discharge to, in part, create surface oxidation. As further examples of surface treatment, the fibers and/or other materials may be exposed to a chemical etchant to, in part, selectively remove portions of the surface and enhance surface roughening; the fibers and/or other materials may be exposed to a flame treatment to, in part, increase bondability; the fibers and/or other materials may be exposed to irradiation to, in part, form grafts to a surface; the fibers and/or other materials may be exposed to a low-temperature, low-pressure glow discharge (i.e., a plasma) to excite species and chemically and physically modify the surface; and/or the fibers and/or other materials may be exposed to ultraviolet light and ozone to increase the number of oxygen functional groups incorporated into the material. (See Gent, et al., “Adhesion,” Encyclopedia of Polymer Science and Technology, Third Edition, 2003, Volume 1, pp. 218-256 (John Wiley & Sons, Inc., Hoboken, N.J.), which is incorporated in its entirety in this application by this reference; see also Finson, et al., “Surface Treatment,” The Wiley Encyclopedia of Packaging Technology, Second Edition, 1997, pp. 867-874 (John Wiley & Sons, Inc., New York, N.Y.), which is incorporated in its entirety in this application by this reference.)

The first general embodiment of the hydraulically-formed nonwoven sheet described in this application may exhibit various properties, as shown and further defined in the examples. These various properties include a basis weight of from about 15 grams/meter2 to about 250 grams/meter² or preferably from about 50 grams/meter² to about 100 grams/meter², an air permeability of at least about 90 Coresta units or preferably of at least about 100 Coresta units, a formation of about 1000 or less or preferably of about 500 or less, a log reduction value of at least about 2 (considering the nature of the hydraulically-formed nonwoven sheet as a porous packaging material) or preferably of at least about 3 (again, considering the nature of the hydraulically-formed nonwoven sheet as a porous packaging material), a bacterial filtration efficiency of at least about 94% or preferably of at least about 99%, a bursting strength of at least about 75 pounds force per square inch gauge or preferably of at least about 120 pounds force per square inch gauge, an average internal tearing resistance of at least about 150 grams or preferably of at least about 275 grams, a slow rate penetration resistance of at least about 25 Newtons or preferably of at least about 40 Newtons, an average tensile strength of at least about 6 kilograms/15 millimeters or preferably of at least about 7 kilograms/15 millimeters and an average stretch of at least about 7% or preferably of at least about 11%.

The nonwoven sheet may be printed. Such printing may include but is not limited to product identification, security identification and tamper-evident means and devices. The hydraulically-formed nonwoven sheet may have a surface energy level of at least about 42 dyne; this dyne level is expected to enhance the printability of the nonwoven sheet.

The hydraulically-formed nonwoven sheet may exhibit heat resistance. As used throughout this application, “heat resistance” means the ability of the nonwoven sheet to maintain dimensional stability and to resist damage and deformation when exposed to elevated temperatures. With due consideration to the melting points of the fibers comprising the sheet (such as polyester fibers with a melting point of about 260° C.), the hydraulically-formed nonwoven sheet may maintain dimensional stability and resist damage and deformation when exposed to temperatures up to about 200° C. This is in contrast to sheets made of polyethylene fibers, such as those sold by E.I. du Pont de Nemours and Company (Wilmington, Del.) under the trademark Tyvek®. Tyvek® sheets are known to maintain dimensional stability and resist damage and deformation when exposed to temperatures only up to about 140° C. or less (considering the melting point of polyethylene is typically in the range of 105° C. to 130° C.). Above 1 40° C. or less, such sheets are known to lose dimensional stability and “transparentize,” as the materials in the sheets melt together and the sheets then resemble transparent flexible packaging films with, in part, significantly reduced air permeability.

The non-woven sheet may comprise one or more authentication markers. Examples of authentication markers include but are not limited to watermarks, embossing, authentication fibers and authentication dyes.

The nonwoven sheet may include an antimicrobial fiber; particle or other material or may be treated with an antimicrobial material. Examples of antimicrobial fibers and particles include but are not limited to natural bamboo fibers, natural chitosans, lysozyme, bacteriocins such as nisin, and synthetic fibers treated with an antimicrobial agent (such as quaternary ammonium compound or octylphenol polyoxoethylene) prior to melt spinning. Examples of antimicrobial treatments include but are not limited to quaternary ammonium compound, naturally occurring genistein (an isoflavone derived from soybeans), conjugated linoleic acid (a fatty acid derived from linoleic acid), propionic acid, colloidal silver, lysozyme and bacteriocins such as nisin.

The nonwoven sheet may be coated on one or both of its sides with a heat-sealable coating material (as defined, in part, below).

The nonwoven sheet may be coated on one or both of its sides with a pressure-sensitive adhesive (PSA) (as defined, in part, below). The PSA may be continuous and applied all over the sheet or may be discontinuous and restricted to pre-determined, discrete sites (e.g., pattern-applied).

The nonwoven sheet may comprise a charge-chemistry modifier. In another embodiment, the charge-chemistry modifier may further comprise a charge-modifying electrokinetic potential treatment such that the electrokinetically charged sheet would repel bacteria with cell walls of similar charge and would attract bacteria will cell walls of opposite charge, where the bacteria are gram-positive or gram-negative in nature.

The non-woven sheet may comprise a single layer or multiple layers. In a multi-layer sheet, a first layer may comprise the first non-cellulosic polymeric fibers and a second layer may comprise the second non-cellulosic polymeric fibers. In another embodiment, in a multi-layer sheet, one of the layers may comprise a scrim material (as defined, in part, below).

The non-woven sheet may exhibit any combination of the above properties. In any given embodiment, it may have one, two, three, four, etc., or all of the above listed properties.

In another embodiment of the first general embodiment of the hydraulically-formed nonwoven sheet described in this application, a package (for an article) comprises the hydraulically-formed nonwoven sheet. The article packaged may be a medical device, desiccant or other item or material. The nonwoven sheet is as described above for the first general embodiment in that it comprises first non-cellulosic polymeric fibers in an amount of from about 5% to about 90% by weight of the nonwoven sheet in its dry state and second non-cellulosic polymeric fibers in an amount of from about 10% to about 95% by weight of the nonwoven sheet in its dry state. The first non-cellulosic polymeric fibers and the second non-cellulosic polymeric fibers are also as described above. As also described above, then nonwoven sheet has various properties.

In one embodiment of the package comprising the hydraulically-formed nonwoven sheet, the package may comprise at least one additional layer that is directly adhered to the nonwoven sheet. (As used throughout this application, “directly adhered” means with no intervening layer.) The additional layer may comprise another hydraulically-formed nonwoven sheet (as described in this application), paper, thermoplastic material (as defined, in part, above), binding material (as defined, in part, above), coating material (as defined, in part, below) or a combination of these. Thermoplastic materials include but are not limited to homopolymers and copolymers of, for example, polyolefins, polyesters, polyamides, polyvinyl acetates, polyvinyl chlorides, polyvinyl alcohols, ionomers or blends of these polymers. The additional layer may be directly adhered to the entire surface of the nonwoven sheet or it may be adhered to only a portion of the nonwoven sheet (as, by way of non-limiting example, where the nonwoven sheet is attached as a lidding sheet to a thermoformed container). The additional layer may cover the nonwoven sheet in its entirety (i.e., be the same size as the nonwoven sheet), may cover only a portion of the nonwoven sheet (i.e., be smaller size than the nonwoven sheet) or may extend beyond the nonwoven sheet (i.e., be larger size than the nonwoven sheet).

In another embodiment of the package comprising the hydraulically-formed nonwoven sheet, the nonwoven sheet may be directly adhered to itself. By way of non-limiting examples, two hydraulically-formed nonwoven sheets may be heat-sealed together along the edges to form a pouch or one hydraulically-formed non-woven sheet may be formed into a tube and heat-sealed via a lap-seal, a fin-seal or other seal configuration.

In a further embodiment of the package comprising the hydraulically-formed nonwoven sheet, the sheet may be thermoformed. Thermoforming and other similar techniques are well known in the art for packaging. See Throne, “Thermoforming,” Encyclopedia of Polymer Science and Technology, Third 1025 Edition, 2003, Volume 8, pp. 222-251 (John Wiley & Sons, Inc., Hoboken, N.J.), which is incorporated in its entirety in this application by this reference; see also Irwin, “Thermoforming,” Modern Plastics Encyclopedia, 1984-1985, pp. 329-336 (McGraw-Hill Inc., New York, N.Y.), which is incorporated in its entirety in this application by this reference; see also “Thermoforming,” The Wiley Encyclopedia of Packaging Technology, Second Edition, 1997, pp. 914-921 (John Wiley & Sons, Inc., New York, N.Y.), which is incorporated in its entirety in this application by this reference. Suitable thermoforming methods include standard, deep-draw, or plug-assist vacuum forming. During standard vacuum forming, a thermoplastic web, such as a film or sheet, is heated, and a vacuum is applied beneath the web allowing atmospheric pressure to force the web into a preformed mold. When relatively deep molds are employed, the process is referred to as a “deep-draw” application. In a plug-assist vacuum forming method, after the thermoplastic web has been heated and sealed across a mold cavity, a plug shape similar to the mold shape impinges on the thermoplastic web; and, upon the application of vacuum, the thermoplastic web conforms to the mold surface. After thermoforming, with due consideration to the melting points of the fibers comprising the sheet (such as polyester fibers with a melting point of about 260*C) and the resulting heat resistance of the nonwoven sheet (as defined above), the physical characteristics (such as bursting strength, internal tearing resistance, tensile strength) of the hydraulically-formed nonwoven sheet are not expected to change significantly.

In another embodiment of the first general embodiment of the hydraulically-formed nonwoven sheet described in this application, a method of packaging a medical device uses a package comprising the hydraulically-formed nonwoven sheet. This method of packaging comprises (1) providing a package comprising a hydraulically-formed nonwoven sheet with first non-cellulosic polymeric fibers and second non-cellulosic polymeric fibers; (2) placing a medical device in the package; (3) enclosing the medical device in the package by forming a continuous closing seal; and (4) introducing a sterilizing gas into the sealed package through the nonwoven sheet. The nonwoven sheet is as described above for the first general embodiment in that it comprises first non-cellulosic polymeric fibers in an amount of from about 5% to about 90% by weight of the nonwoven sheet in its dry state and second non-cellulosic polymeric fibers in an amount of from about 10% to about 95% by weight of the nonwoven sheet in its dry state. The first non-cellulosic polymeric fibers and the second non-cellulosic polymeric fibers are also as described above. As also described above, the nonwoven sheet has various properties.

In accordance with this method of packaging, a package comprising the first general embodiment of the hydraulically-formed nonwoven sheet is provided, and a medical device is placed in the package. Non-limiting examples of medical devices that may be packaged are tongue depressors, bedpans, dental instruments, surgical instruments (e.g., probes, scalpels, clamps, scissors, needles), infusion pumps, surgical drapes, suture materials, heart valves, prosthetic joints and other prosthetics, stents and other devices.

The medical device is then enclosed in the package by forming a continuous closing seal. This continuous closing seal includes but is not limited to a heat seal, a weld seal, an ultrasonic seal, an adhesive seal or a combination of such seals.

Heat seals may be formed by a hot bar sealer. In using a hot bar sealer, adjacent polymeric layers of the package are held together by opposing sealer jaws of which at least one is heated to cause the adjacent polymeric layers to fusion bond by application of heat and pressure across the area to be sealed. Although specific seal conditions will vary depending upon the thickness, package materials used, package configuration, sealing equipment and other variables, a suitable seal using typical equipment known in the art may be achieved with a seal time from about 0.5 seconds to about ten seconds using an upper jaw seal temperature of from about 120° C. to about 250° C., a lower jaw seal temperature of from about 20° C. to about 100° C. and a seal pressure of from about 40 pounds force per square inch to about 150 pounds force per square inch. In one embodiment, a seal time of about 0.5 seconds with an upper jaw seal temperature of at least about 120° C. and a seal pressure of about 40 pounds force per square inch may be employed; in this embodiment, the lower jaw seal is at ambient temperature. Additionally in another embodiment, with due consideration to the melting points of the fibers comprising the hydraulically-formed nonwoven sheet (such as polyester fibers with a melting point of about 260° C.) and the resulting heat resistance of the nonwoven sheet (as defined above), the package comprising the sheet may be sealed with an upper jaw seal temperature of from about 180° C. to about 200° C.

Heat seals may be formed by an impulse sealer. An impulse seal is formed via application of heat and pressure using opposing bars similar to that of the hot bar sealer except that at least one of the bars has a covered wire or ribbon through which electric current is passed for a brief time period to cause the adjacent layers to fusion bond.

With due consideration to the melting points of the fibers comprising the sheet (such as polyester fibers with a melting point of about 260° C.) and the resulting heat resistance of the nonwoven sheet (as defined above), after a medical device is enclosed in package by forming a continuous heat seal, the nonwoven sheet is expected to retain an air permeability of at least about 100 Coresta units, a bacterial filtration efficiency of at least about 99%, a bursting strength of at least about 120 pounds force per square inch gauge, an average internal tearing resistance of at least about 275 grams, a slow rate penetration resistance of at least about 40 Newtons and an average tensile strength of at least about 7 kilograms/15 millimeters.

The next step in the method of packaging a medical device using a package comprising the hydraulically-formed nonwoven sheet is introducing a sterilizing gas into the sealed package. The sterilizing gas enters the package through the permeable, hydraulically-formed nonwoven sheet. The sterilizing gas may comprise dry heat, steam, ethylene oxide, or a combination of such.

In the dry heat sterilization process, the packaged product is brought to elevated temperatures for an extended period of time. The combination of the heat and the time result in a sterilized product.

Steam (“wet heat”) sterilization processes include steam sterilization with controlled pressure (as in autoclaving) and steam sterilization without controlled pressure. The more common steam sterilization process is the autoclaving process where the pressure is controlled and a super-heated steam results in faster sterilization.

With due consideration to the melting points of the fibers comprising the sheet (such as polyester fibers with a melting point of about 260° C.) and the resulting heat resistance of the nonwoven sheet (as defined above), the dry heat and steam sterilization processes may utilize higher sterilization temperatures, resulting in significant decreases in sterilization times.

When ethylene oxide is used as the sterilizing gas, the ethylene oxide must be removed from the package. Removing the sterilizing gas may comprise flushing the package with an inert gas, applying a vacuum to the package or a combination of these removal methods.

The inert gas used to flush the package may be nitrogen. The nitrogen may be flushed for a time sufficient to remove the ethylene oxide. For example, a suitable flush time may be from about one second to about ten seconds at a pressure of from about 10 pounds force per square inch to about 30 pounds force per square inch or preferably for about five seconds to about ten seconds at a pressure of 30 pounds force per square inch. Longer flush times may be used if desired for the particular package configuration.

The vacuum may be applied for a time sufficient to remove the desired quantity of gas. For example, the vacuum may be applied for from about one second to about ten seconds or preferably for from about five seconds to about ten seconds. Vacuum times may vary depending on the package configuration, the quantity of gas to be removed, the items packaged and other variables.

In a further embodiment of the method of packaging a medical device using a package comprising the hydraulically-formed nonwoven sheet, the package may comprise active package tracer indicators, such as those for detecting the elimination of bacteria, the completion of sterilization, the presence of any package leaks or the achievement of maximum sterilization temperatures.

In another embodiment of the first general embodiment of the hydraulically-formed nonwoven sheet described in this application, the hydraulically-formed nonwoven sheet may be manufactured by a method comprising the sequential steps of (1) adding materials to a hydropulper, (2) agitating the materials added to the hydropulper to form a furnish, (3) delivering the furnish from the hydropulper to holding means, (4) delivering the furnish from the holding means to a forming section to form a web, (5) dewatering the web on the forming section, (6) couching the web to deliver the web to a pressing section, (7) pressing the web, (8) delivering the web to a drying section and (9) drying the web. The materials added to the hydropulper comprise water, first non-cellulosic polymeric fibers in an amount of from about 5% to about 90% by weight of the nonwoven sheet in its dry state and second non-cellulosic polymeric fibers in an amount of from about 10% to about 95% by weight of the nonwoven sheet in its dry state. The first non-cellulosic polymeric fibers and the second non-cellulosic polymeric fibers are as described above. As also described above, the nonwoven sheet manufactured has various properties.

Third non-cellulosic polymeric materials in an amount up to about 50% by weight of the nonwoven sheet in its dry state may be added to the hydropulper. The third non-cellulosic polymeric materials are as described above.

Cellulosic based materials in an amount up to about 75% by weight of the nonwoven sheet in its dry state may be added to the hydropulper. The cellulosic based materials are as described above.

Binding material in an amount up to about 40% by weight of the nonwoven sheet in its dry state may be added to the hydropulper. The binding material is as described above.

Other fibers and materials including but not limited to antimicrobial fibers, particles and/or materials (as defined, in part, above), wetting chemistries, wet-strength chemistries, formation chemistries, charge-chemistry modifiers (as defined, in part, above), retention aids and/or sizing agents may also be added to the hydropulper.

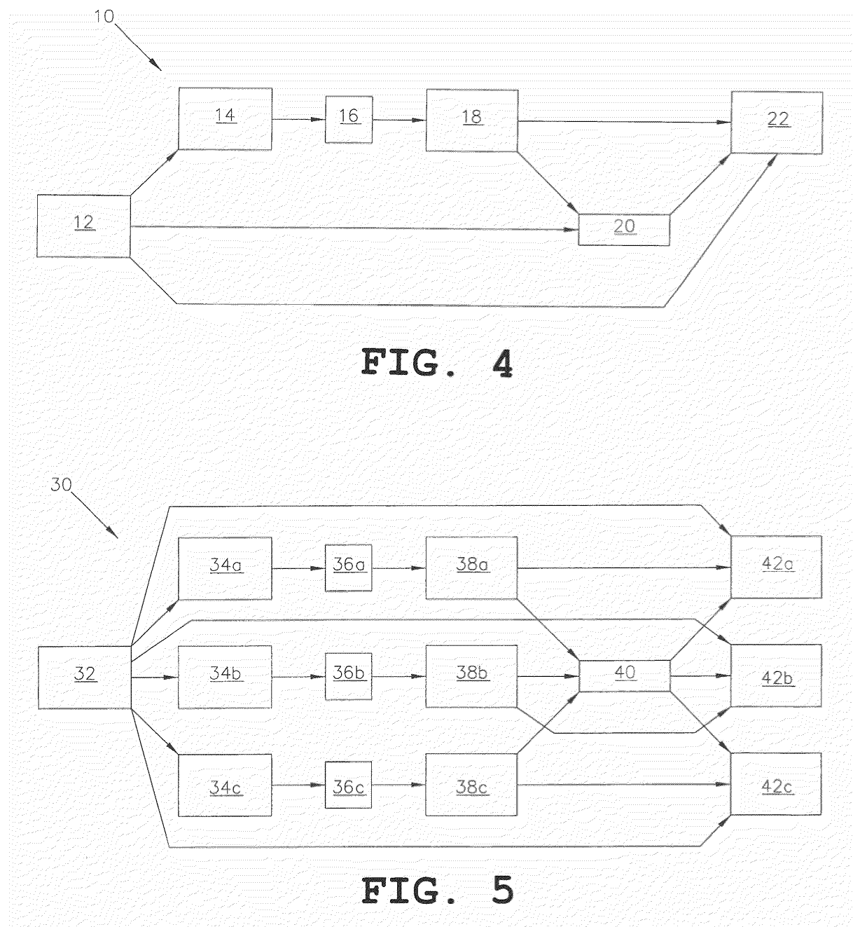

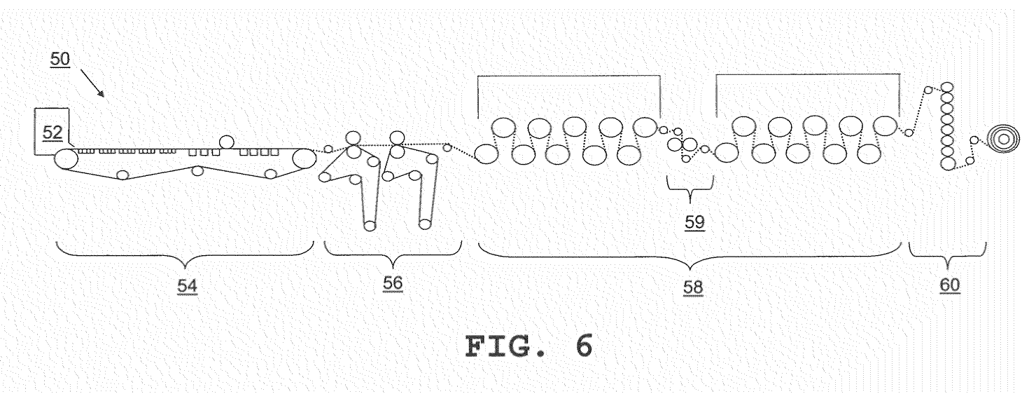

In one embodiment, the method for manufacturing a hydraulically-formed nonwoven sheet of the first general embodiment includes a stock preparation system and an apparatus for manufacturing. FIG. 4 is a schematic representation of a first embodiment of a stock preparation system for an apparatus 50 for manufacturing a hydraulically-formed nonwoven sheet (see FIG. 6). The stock preparation system of FIG. 4 is basic stock preparation system 10. Materials are added to hydropulper 12. Materials that are added to hydropulper 12 are water, first non-cellulosic polymeric fibers and second non-cellulosic polymeric fibers. Materials that may be added to hydropulper 12 include third non-cellulosic polymeric fibers, cellulosic based materials, binding materials and other fibers, materials and additives. The materials added to hydropulper 12 are agitated until the fibers are in uniform suspension and a furnish is formed.

If the furnish does not comprise materials needing refining, the furnish may be delivered to blend chest 20 or machine chest 22. If it is to be blended with one or more other furnishes, the furnish is delivered to blend chest 20 where it is blended with the other furnish(es) and the blended furnish is then delivered to machine chest 22. If it is not to be blended with another furnish, the non-refined furnish is delivered to machine chest 22. From machine chest 22, the furnish is delivered to forming section 54 of apparatus 50 for manufacturing a hydraulically-formed nonwoven sheet. (see FIG. 6).

If the furnish comprises materials needing refining, such as some cellulosic based materials, the furnish is delivered to refiner feed chest 14. This furnish is then delivered to refiner 16, refined and delivered to refined stock chest 18. The refined furnish may then be delivered to blend chest 20 or machine chest 22. If it is to be blended with another furnish or other furnishes, the refined furnish is delivered to blend chest 20, where it is blended with the other furnish(es); and the blended furnish is then delivered to machine chest 22. If it is not to be blended with another furnish, the refined furnish is delivered to machine chest 22. From machine chest 22, the furnish is delivered to forming section 54 of apparatus 50 for manufacturing a hydraulically-formed nonwoven sheet (see FIG. 6).

Once a furnish is emptied from hydropulper 12, additional materials may be added to hydropulper 12 and additional furnishes may be formed. The additional furnishes may be delivered directly to blend chest 20 or machine chest 22, as described above. The additional furnishes may alternatively be delivered to refiner feed chest 14, refined in refiner 16, delivered to refined stock chest 18 and then delivered to blend chest 20 or machine chest 22, as described above.

As a first non-limiting example, water, first non-cellulosic polymeric fibers, second non-cellulosic polymeric fibers, third non-cellulosic polymeric materials and cellulosic based materials are added to hydropulper 12 and agitated until the fibers are in uniform suspension and a furnish is formed. The cellulosic based materials in this furnish do not need refining, and the furnish is not to be blended with another furnish. Therefore, the furnish is sent to machine chest 22. The machine chest 22 serves as holding means, holding the furnish for delivery to forming section 54 of apparatus 50 for manufacturing a hydraulically-formed nonwoven sheet (see FIG. 6).

As a second non-limiting example, water, first non-cellulosic polymeric fibers, second non-cellulosic polymeric fibers and third non-cellulosic polymeric materials are added to hydropulper 12 and agitated until the fibers are in uniform suspension and a first furnish is formed. This first furnish does not comprise any materials needing refining, but it is to be blended with a second furnish. Therefore, this first furnish is delivered to blend chest 20. Blend chest 20 delivers to machine chest 22. Therefore, blend chest 20 delivering to machine chest 22 serves as holding means for the first furnish. Once this first furnish is delivered to these holding means and hydropulper 12 is emptied, water and cellulosic based materials are added to hydropulper 12 and agitated until the fibers are in uniform suspension and a second furnish is formed. This second furnish does comprise materials needing refining. So, this second furnish is delivered to refiner feed chest 14, refined in refiner 16 and delivered to refined stock chest 18. This second furnish is to be blended with the first furnish and is, therefore, delivered to blend chest 20, which after blending delivers to machine chest 22. Blend chest 20 delivering to machine chest 22 also serves as holding means for the second furnish. The first furnish is blended with the second furnish in blend chest 20 and then the blended furnish is delivered to machine chest 22. The blend chest 20 delivering to machine chest 22 further serves as holding means for the blended furnish, holding the blended furnish for delivery to forming section 54 of apparatus 50 for manufacturing a hydraulically-formed nonwoven sheet (see FIG. 6).

FIG. 5 is a schematic representation of a second embodiment of a stock preparation system for an apparatus for manufacturing a hydraulically-formed nonwoven sheet. The stock preparation system of FIG. 5 is more complex stock preparation system 30. More complex stock preparation system 30 includes hydropulper 32, refiner feed chests 34a, 34b and 34c, refiners 36a, 36b, 36c, refined stock chests 38a, 38b, 38c, blend chest 40 and machine chests 42a, 42b, 42c. FIG. 5 depicts one hydropulper, three refined feed chest, three refiners, three refined stock chests, one blend chest and three machine chests; however, more complex stock preparation system 30 is not limited to any number of such apparatuses. The principles of more complex stock preparation system 30 are similar to those outlined above for basic stock preparation system 10. However, more complex stock preparation system 30 may be used to form a web with multiple layers.

As a third non-limiting example, water and first non-cellulosic polymeric fibers are added to hydropulper 32 and agitated until the fibers are in uniform suspension and a first furnish is formed. This first furnish does not comprise any materials needing refining. Therefore, first refiner feed chest 34a, first refiner 36a and first refined stock chest 38a are bypassed. Also, this first furnish is not to be blended with another furnish. Therefore, blend chest 40 is also bypassed and the first furnish is delivered to first machine chest 42a. First machine chest 42a serves as holding means for the first furnish, holding the first furnish for delivery to a first forming section of an apparatus for manufacturing a hydraulically-formed nonwoven sheet.

Once this first furnish is delivered to first machine chest 42a and hydropulper 32 is emptied, water and second non-cellulosic polymeric fibers (and possibly other materials and fibers, such as third non-cellulosic polymeric fibers) are added to hydropulper 32 and agitated until the fibers are in uniform suspension and a second furnish is formed. This second furnish also does not comprise any materials needing refining. Therefore, second refiner feed chest 34b, second refiner 36b and second refined stock chest 38b are bypassed. Also, this second furnish is not to be blended with another furnish. Therefore, blend chest 40 is also bypassed and the second furnish is delivered to second machine chest 42b. Second machine chest 42b serves as holding means for the second furnish, holding the second furnish for delivery to a second forming section of an apparatus for manufacturing a hydraulically-formed nonwoven sheet.

Before a furnish is delivered from a machine chest to an apparatus for manufacturing a hydraulically-formed nonwoven sheet, additional water may be added to the furnish to reduce the solids content from about 1% to as low as 0.005%. The additional water allows for additional fiberdispersion. Also, before a furnish is delivered from a machine chest to an apparatus for manufacturing a hydraulically-formed nonwoven sheet, additional materials may be added to the furnish. These optional additional materials include binding material in an amount of up to 40% by weight of the nonwoven sheet in its dry state may be added to the furnish. The binding material is as described above. These optional additional materials also include but are not limited to antimicrobial materials and treatments (as defined, in part, above), wetting chemistries, wet-strength chemistries, formation chemistries, charge-chemistry modifiers (as defined, in part, above), retention aids and/or sizing agents.

FIG. 6 is a diagrammatic representation of apparatus 50 for manufacturing a hydraulically-formed nonwoven sheet. FIG. 6 includes one forming section 54. However, apparatus 50 may comprise more than one forming section 54. Each forming section 54 forms a layer of the sheet or web formed by apparatus 50. Therefore, in the third non-limiting example above, the first furnish delivered to the first forming section forms a first layer, the second furnish delivered to the second forming section forms a second layer, and apparatus 50 forms a two-layer web or sheet.

Returning to FIG. 6, the furnish is delivered through headbox (or other device, such as slice or cylinder) 52 to forming section 54. Multiple headboxes (not pictured) as well as multiple slices (not pictured) or multiple cylinders (not pictured) may be used to deliver multiple furnishes from multiple machine chests 42a, 42b, 42c (see FIG. 5) to multiple forming sections (not pictured) so that apparatus 50 forms a multi-layer sheet or web. Forming section 54 may be a Fourdrinier, as pictured. Forming section 54 may also or alternatively be a cylinder (not pictured), rotoformer (not pictured) or inclined wire former (not pictured). (See Chapman, “Nonwoven Fabrics, Staple Fibers,” Encyclopedia of Polymer Science and Technology, Third Edition, 2004, Volume 10, pp. 614-637 (John Wiley & Sons. Inc., Hoboken, N.J.), which is incorporated in its entirety in this application by this reference; see also “Paperboard,” The Wiley Encyclopedia of Packaging Technology, Second Edition, 1997, pp. 717-723 (John Wiley & Sons, Inc., New York, N.Y.), which is incorporated in its entirety in this application by this reference.) In forming section 54, the furnish flows onto a forming fabric which moves over dewatering modules such as suction boxes, foils and curvatures. The dewatering modules allow water to drain from the fabric and result in a continuous web of approximately 20-30% solids. A scrim material (as defined, in part, below) may be added to this continuous web in forming section 54. This continuous web, either with or without scrim material, is strong enough to be removed from forming section 54 in a process known as “couching.” The removed or couched web has a wet process tensile strength of at least about 100 grams/30 millimeters. The removed or couched web is delivered to pressing section 56.

In pressing section 56, the web passes through a series of presses composed of sets of two rolls. The two rolls are pressed together with high pressure to create a nip. The web, along with a continuous felt, is passed between the nip; and additional water is removed from the web and transported into the continuous felt, resulting in a web of approximately 40-50% solids. A scrim material (as defined, in part, below) may be added to the web in pressing section 56.

The web is then delivered to drying section 58. Drying section 58 comprises multiple large cylinders, which may be heated internally with steam. The web passes over the cylinders and additional water is removed from the web. Other systems that may be used to evaporate remaining water include through air dryers, which transfer thermal energy to the web without contacting the web. At the end of drying section 58, the web has a solid content of approximately 95%.

Drying section 58 may include a breaker stack (not pictured). The breaker stack includes calender rolls (similar to calender rolls 60 described below). As such, the breaker stack applies a high level of compression to the web and results in pre-densification (as it occurs prior to calendering) of the web. Increased pressure at the nip(s) in pressing section 56 and/or at cylinders, nips or otherwise in drying section 58 may also result in pre-densification of the web, eliminating the need for a separate breaker stack. The pre-densification pressure at the calender rolls or otherwise may be from about 100 pounds force per lineal inch to about 1500 pounds force per lineal inch, preferably from about 150 pounds force per lineal inch to about 800 pounds force per lineal inch or more preferably from about 220 pounds force per lineal inch to about 500 pounds force per lineal inch. Pre-densifying the web increases chemical and mechanical bonding, reduces thickness variation and may reduce and/or eliminate tinting and fiber tear.

Drying section 58 may include impregnator 59. Impregnator 59 is placed after the initial large cylinders (for initial drying). Impregnator 59 may be a size press (as pictured), a spray shower or other device. In a size press, two hard rolls create a nip through which the web passes. Binding material is added to either or both sides of the web, creating a pond of liquid binding material. The binding material is then absorbed into the web and further driven into the web by the nip. In a spray shower, either or both sides of the web are sprayed with binding material which is then absorbed into the web.

Impregnator 59 may add binding material to the web. The binding material is as described above.

Impregnator 59 may add heat-sealable coating material to the web. The heat-sealable coating materials may be proprietary ethylene vinyl acetate (EVA) based formulations or may be commercially available materials, such as Adcote™ from Rohm and Haas Chemicals, LLC (Philadelphia, Pa.) or Latiseal® from Henkel AG & Co. KGaA (Düsseldorf, Germany). Heat-sealable coating materials are designed to allow the web or sheet to be sealed to other materials, such as at least one layer of paper, thermoplastic material (as defined, in part, above) or other material. Heat-sealable coating materials are also designed to be permeable to sterilizing gases, maintaining acceptable air permeability for a hydraulically-formed nonwoven sheet.

Impregnator 59 may add pressure-sensitive adhesive (PSA) to the web. The PSA added to the web is not expected to significantly affect the air permeability of the nonwoven sheet. Many PSA compositions comprise a base elastomeric resin and a tackifier which enhances the ability of the adhesive to instantly bond and enhances the bond strength. Examples of elastomers used as the base resin in tackified multicomponent PSAs include natural rubber, polybutadiene, polyorganosiloxanes, styrene-butadiene rubber, carboxylated styrene-butadiene rubber, polyisobutylene, butyl rubber, halogenated butyl rubber, block polymers based on styrene with isoprene, butadiene, ethylene-propylene or ethylene-butylene, or combinations of such elastomers. (See Yorkgitis, “Adhesive Compounds,” Encyclopedia of Polymer Science and Technology, Third Edition, 2003, Volume 1, pp. 256-290 (John Wiley & Sons, Inc., Hoboken, N.J.), which is incorporated in its entirety in this application by this reference.)

Impregnator 59 may add antimicrobial materials and treatments (as defined, in part, above), wetting chemistries, wet-strength chemistries, formation chemistries, charge-chemistry modifiers (as defined, in part, above), retention aids and/or sizing agents.

After the web is dried in drying section 58, it may pass through calender rolls 60. Calender rolls 60 include one or more nips and further densify the sheet and reduce thickness variation. The pressure of calender rolls 60 may be from about 100 pounds force per lineal inch to about 1500 pounds force per lineal inch, preferably from about 150 pounds force per lineal inch to about 800 pounds force per lineal inch or more preferably from about 220 pounds force per lineal inch to about 500 pounds force per lineal inch. Calender rolls 60 may be heated to a temperature of from about 65° C. to about 205° C., preferably from about 65° C. to about 95° C. Calender rolls 60 may create a smooth surface and improve the feel and other properties (including surface (e.g., tinting and fiber tear) and otherwise) for the web. Calender rolls 60 are commonly composed of steel but may also or alternatively be composed of softer materials such as rubber, polyurethane or other polymeric materials or cotton or flax or other naturally occurring cellulosic materials. Calender rolls 60 that use higher levels of pressure, numbers of nips and temperatures are commonly referred to as supercalenders.

Calender rolls 60 may be used to bond, embed or form a scrim material (i.e., a material with an open structure) to the web as an additional layer to impart strength. Scrim materials include but are not limited to open, light-weight nonwoven materials, such as JM Spunbond Polyester Mats from Johns Manville (Denver, Colo.) or nylon nonwoven materials from Cerex Advanced Fabrics, Inc. (Pensacola, Fla.). Scrim materials also include but are not limited to open-mesh woven materials or open-mesh laid materials, such as Bayex® from Saint-Gobain Technical Fabrics (Grand Island, N.Y.).

In a second general embodiment of the invention, a hydraulically-formed nonwoven sheet comprises binding material, non-cellulosic polymeric fibers and cellulosic based materials and has a bacterial filtration efficiency of at least about 98%.

The binding material is as described above for the first general embodiment. The binding material comprises acrylic latex (such as styrene butadiene copolymer or butadiene acrylonitrile copolymer), polyurethane, polyvinyl acetate, polyvinyl alcohol, natural rubber or other nature-based adhesive, polyvinyl chloride, polychloroprene, epoxy, phenol, urea-formaldehyde, thermal melt adhesive, surface treatment material, surface treatment method, binder fiber, crosslinking agent, tackifier or blends of such. Binding material is present in the second general embodiment of the hydraulically-formed nonwoven sheet in an amount of from about 5% to about 40% by weight of the nonwoven sheet in its dry state.

The non-cellulosic polymeric fibers are as described above for the first non-cellulosic polymeric fibers of the first general embodiment. The non-cellulosic polymeric fibers have an average diameter less than about 3.5 micron, an average cut length less than about 3 millimeters and an average aspect ratio of about 400 to about 2000. The non-cellulosic polymeric fibers are present in the second general embodiment of the hydraulically-formed nonwoven sheet in an amount of from about 5% to about 40% by weight of the nonwoven sheet in its dry state. Additionally, as described above, the non-cellulosic polymeric fibers of the second general embodiment may comprise polymers including homopolymers and copolymers of, for example, polyolefin, polyester, polyamide, polylactide, polycaprolactone, polycarbonate, polyurethane, polyvinyl acetate, polyvinyl chloride, polyvinyl alcohol, polyacrylate, polyacrylonitrile, ionomer or blends of these polymers. Examples of polyolefins include but are not limited to polyethylene, polypropylene, propylene-ethylene copolymers and ethylene a-olefin copolymers. An example of a polyester includes but is not limited to polyethylene terephthalate; FIG. 2 is the chemical structure of polyethylene terephthalate. An example of an ionomer includes but is not limited to Surlyn®, which is available from E.I. du. Pont de Nemours and Company (Wilmington, Del.). As also described in the first general embodiment, the non-cellulosic polymeric fibers of the second general embodiment may be oriented.

The cellulosic based materials are as described above for the first general embodiment. The cellulosic based materials comprise (a) fibers manufactured from cellulose; (b) naturally occurring cellulosic materials selected from hardwood fibers, softwood fibers, non-wood fibers or blends thereof; or (c) blends of fibers manufactured from cellulose and naturally occurring cellulosic materials. The cellulosic based materials are present in the second general embodiment of the hydraulically-formed sheet in an amount of from about 45% to about 75% by weight of the nonwoven sheet in its dry state.

As described for the hydraulically-formed nonwoven of the first general embodiment, additional fibers and materials may be added to the nonwoven sheet of the second general embodiment.

The hydraulically-formed nonwoven sheet of the second general embodiment may have properties similar to the hydraulically-formed nonwoven sheet of the first general embodiment, including but not limited to a basis weight of from about 15 grams/meter² to about 250 grams/meter², an air permeability of at least about 90 Coresta units, a formation of about 1000 or less and a bacterial filtration efficiency of at least about 99%. Additionally, the nonwoven sheet may be printed. Such printing may include but is not limited to product identification, security identification and tamper-evident means and devices. This hydraulically-formed nonwoven sheet may have a surface energy level of at least about 42 dyne; this dyne level is expected to enhance the printability of the nonwoven sheet.

Furthermore, as described above for the first general embodiment, a package (for an article) may comprise the hydraulically-formed nonwoven sheet of the second general embodiment; and, as described above for the first general embodiment, a method of packaging a medical device may use a package comprising the hydraulically-formed nonwoven sheet of the second general embodiment. Also, the hydraulically-formed nonwoven sheet of the second general embodiment may be manufactured by the method as described above for the hydraulically-formed nonwoven sheet of the first general embodiment.

### EXAMPLES—Set I

Wet process tensile strength was determined for various samples. Wet process tensile strength is defined as the tensile strength of a sheet after the sheet is couch rolled and removed from the forming section but prior to any wet pressing or drying. It is an important production performance characteristic, as it indicates the ability of the sheet to be run from the forming section through the pressing and drying sections. In other words, it indicates the ability of the sheet to be couched.

Comparative Examples A-F and Examples A-C are handsheets formed as follows: Any cellulosic based materials to be included in the handsheet were refined to 400 CSF, as needed. The cellulosic based materials were refined in either an 80 mm single disk at a plate clearance of 0.25 mm for approximately 30 minutes or a five-inch rotary refine under load for approximately five minutes. The test specimen was obtained by first determining the amount of fibers to weigh. For example, for a 100 g/m² handsheet produced with a 250 mm×300 mm Williams handsheet mold, a total of 7.5 grams of fibers (on a dry weight basis) was weighed. The fibers were then added to the pulper bowl of a two-liter TAPPI Standard pulper. 2000 mL of warm (80° F.-90°) water was also added to the pulper bowl, and the pulping cycle was initiated. The fibers and water were pulped for three minutes or 9000 revolutions. For additional dispersion, as needed, the fibers and water were pulped for an additional two minutes or 6000 revolutions.

Twenty liters of warm (80° F.-90°) water was then added to the handsheet mold, ensuring that the water line was above the wire screen. The pulped fibers and water were then poured into the handsheet mold. A stirrer plate was used to stroke the liquid three times vertically. The stirrer plate was then pulled diagonally to a corner and removed. After five seconds, the handsheet drop valve was pulled and the pulped fibers and water were allowed to drain, with the pulped fibers retained by the wire screen. The smooth side of a first sheet of 750 g/m² blotter paper was placed on the top of the handsheet formed on the wire screen. A couch roller was then used to flatten the formed handsheet onto the blotter paper. The wire screen with the formed handsheet was then raised; and the wire screen, with the formed handsheet and the first sheet of blotter paper, was inverted onto a second sheet of 750 g/m² blotter paper. After two minutes, the inverted screen was raised vertically, and the two sheets of blotter paper and the formed handsheet were horizontally peeled off the wire screen. The second sheet of blotter paper was removed. Plastic wrap was then placed over the formed handsheet and the first sheet of blotter paper to preserve the percent moisture in the couch-rolled handsheet.

Following the above procedure, handsheets for Comparative Examples A-F and Examples A-C were made with the percentages of fibers (on a dry weight basis), as shown in TABLE 1.

TABLE 1

| | 2.5 | | | | Northern |
|---|---|---|---|---|---|
| | micron | | 18 Micron | Nano- | Bleached |
| | 1.5 mm | 7 Micron | 12 mm | fibrillated | Softwood |
| | PET | 5 mm PET | PET | Lyocell | Kraft |
| Comp Ex A | 100.00 | | | | |
| Comp Ex B | | | | | 100.00 |
| Comp Ex C | | | | 100.00 | |
| Comp Ex D | 50.00 | | | | 50.00 |
| Comp Ex E** | | 100.00 | | | |
| Comp Ex F** | | | 100.00 | | |
| Example A | 50.00 | 50.00 | | | |
| Example B | 22.00 | 58.00 | 13.00 | 7.00 | |
| Example C | 21.00 | 43.50 | 7.50 | 14.00 | 14.00 |

Comparative Example E and Comparative Example F each failed to form a testable handsheet.

Comparative Examples A-D and Examples A-C were then prepared for wet process tensile strength testing. Within fifteen minutes after forming the handsheet, the formed handsheet and the first sheet of blotter paper were cut using a Dietz RS45 45 mm-diameter rotary cutter and metal rule to obtain test samples measuring 30 mm wide and at least 130 mm long. Immediately after cutting, the handsheet test sample was peeled from the first sheet of blotter paper and placed on an Al 2971 Wet Tensile Strength Tester. The immobile and mobile specimen plates on the A12971 were locked together. The handsheet test sample was placed across the top of the plates and fastened in place. The locking mechanism for the mobile plate was released, and the water drip value on the 300 ml cylinder on the A12971 was opened. The mobile plate was then driven by the weight of water accumulated in a catch container under the water drip valve. Wet process tensile strength was recorded in grams/30 mm based on the milliliters of water present in the catch container when the handsheet test sample broke.

The wet process tensile strength determined for each of Comparative Examples A-F and Examples A-C is recorded in TABLE 2. The recorded values represent an average of five samples tested for each example.

TABLE 2

| | Wet Process Tensile |
|---|---|
| | Strength (g/30 mm) |
| Comp Ex A | 282.00 |
| Comp Ex B | 131.00 |
| Comp Ex C | 186.00 |
| Comp Ex D | 229.00 |
| Comp Ex E** | 0 (no formed sheet) |
| Comp Ex F** | 0 (no formed sheet) |
| Example A | 338.00 |
| Example B | 327.00 |
| Example C | 358.00 |

Examples A-C combine first non-cellulosic polymeric fibers and second non-cellulosic polymeric fibers. Surprisingly, these handsheets show significant improvement in wet process tensile strength, compared to the values for a handsheet with 100% of the first non-cellulosic polymeric fibers (Comparative Example A at 282 g/30 mm) and for a handsheet with 100% of the second non-cellulosic polymeric fibers (Comparative Example E at 0 g/30 mm). The substantial flexibility of the first non-cellulosic polymeric fibers and the resulting mechanical entanglement with the second non-cellulosic polymeric fibers may contribute to these surprising results.

### EXAMPLES—Set II

Comparative Example 1 is a first sheet of spunlaid continuous high-density polyethylene fibers, specifically, a sheet of Tyvek® 1073B, available from E.I. du Pont de Nemours and Company (Wilmington, Del.).

Comparative Example 2 is a second sheet of spunlaid continuous high-density polyethylene fibers, specifically, a sheet of Tyvek® 2FSB™, available from E. I. du Pont de Nemours and Company (Wilmington, Del.).

Comparative Example 9 is a sheet of medical-grade paper, specifically, a sheet of Neenah Paper 85 g/m² Grade S-89144, available from Neenah Paper, Inc. (Alpharetta, Ga.).

Comparative Examples 7, 8 and 10 and Examples 19-23 and 33-34 are handsheets formed based on TAPPI Test Method T 205 sp-02, “Forming handsheets for physical tests of pulp.” TAPPI Test Method T 205 sp-02 is incorporated in its entirety in this application by this reference. In forming these handsheets, TAPPI Test Method T 205 sp-02 was followed, with the following exceptions.

Regarding test specimen, instead of obtaining a specimen of 24±0.5 g moisture-free fiber, for a handsheet with a basis weight of 100 g/m², fiber components were weighed out to yield a 1.97 gram dry weight sheet after addition of a binder material (if any).

Regarding disintegration, instead of diluting the specimen to 2000 mL and disintegrating at 3000 rpm until all fiber bundles are dispersed (not to exceed 50,000 revolutions), fiber components were diluted to 1400 mL in a Breville-modified 1400 mL hydropulper. Smaller, shorter fibers (such as the first non-cellulosic polymeric fibers, if any, and cellulosic based materials, if any) were diluted first, followed by larger, longer fibers (such as the second non-cellulosic polymeric fibers, if any) and then followed by even larger, longer fibers (such as the third non-cellulosic polymeric fibers, if any). Fifteen—thirty seconds of agitation occurred between the additions of different size fibers.

Regarding sheetmaking, the standard six-inch perforated stirrer was replaced with a three-inch open-blade stirrer.

Regarding couching, the standard couch roll was replaced with a four-inch Speedball® rubber roller.

Regarding pressing, a pressing step was not used.

Regarding drying, instead of placing a heavy weight on top of a stack of drying rings, or clamping them together with suitable clamping system, and then using an overnight drying period, a handsheet was transferred from the blotter paper used in the couching step to a sheet of foil-backed release paper, and a drying ring was placed on the handsheet on the foil-backed release paper. The handsheet, the foil-backed release paper and the drying ring were then placed in a Euro-Pro convection oven at 200° F.-225° F. for 15-30 minutes or until dry. Rapid drying is possible because of the percentage of non-cellulosic polymeric fibers in the handsheets.

Regarding binding material, for handsheets with a binding material (Comparative Examples 7, 8 and 10 and Examples 19-20, 22-23 and 33-34), a binder addition step was added. After drying, the handsheet was transferred to a new sheet of foil-backed release paper. The binding material was prepared by diluting the binding material to 5% solids in distilled water. The amount of binding material to be added was calculated. For example, for binding materials in an amount of 25% by weight of a handsheet with a basis weight of 100 g/m² in its dry state, about 10 mL of the 5% solution was added to the handsheet; for binding materials in an amount of 28% by weight of a handsheet with a basis weight of 100 g/m² in its dry state, about 11 mL of the 5% solution was added to the handsheet. The binding material was placed on the handsheet via a 3-mL syringe or a 3-mL pipette. Approximately 50% of the total amount of binding material was placed on one side of the handsheet. A two-inch Speedball® rubber roller was then used to roll the binding material into the handsheet. The handsheet was then turned over, and the remaining amount of binding material was placed on the other side and rolled into the handsheet with the roller. A drying ring was then placed over the handsheet and the foil-backed release paper. The handsheet, the foil-backed release paper and the drying ring were then placed in a Euro-Pro convection oven at 200® F.-225° F. for 15-30 minutes or until dry. After fifteen minutes in the oven, the handsheet may be removed and re-rolled to improve surface smoothness. After any re-rolling, the sheet is returned to the oven to finish drying as needed.

Regarding calendening, for handsheets that were calendered (Comparative Examples 7, 8 and 10 and Examples 19 and 21-23), a calendering step was added. A pilot calender from Wheeler Roll Company (Kalamazoo, Mich.) was used to calender the handsheets. (This pilot calender has a ¾ horsepower Reliance Duty Master gear motor with initial 1725 rpm reduced to 30 rpm, pressure ranges from 0-600 pounds force per square inch gauge for the low pressure gauge and from 0-10,000 pounds force per square inch gauge for the high pressure gauge, two hydraulic cylinders on each axle with a one-inch diameter piston for a total hydraulic area of 1.57 inch², two solid stainless steel calender rolls each with 127 mm diameter and 210 mm width, and two 1680-watt, 5700-BTU heat guns each with aluminum heat deflector shields.) The calender rolls were lightly engaged and the motor to turn the rolls was initiated. The heat guns were also initiated to heat the calender rolls to 90° C. After about two hours of heating time, the temperature of the calender rolls was verified with an Extech® Instruments Mini IR Thermometer (with an operating range of −50° C. to 380° C., calibrated to an emissivity of 0.95). Once the temperature of the calender rolls reached 90° C., the heat guns were deactivated; and the calender rolls were allowed to turn for about five minutes (to allow the calender rolls to reach equilibrium). The hydraulic lever was pumped until a pressure of 700 pounds force per square inch gauge (about 220 pounds force per lineal inch) was reached. The handsheet was then feed into the nip through the slot in the safety guard. The sheet was allowed to turn through the nip four times. The calender rolls were then stopped. The handsheet was removed from one of the calender rolls (to which it adhered lightly) with a small spatula.

With the above changes to TAPPI Test Method T 205 sp-02, handsheets for Comparative Examples 7, 8 and 10 and Examples 19-23 and 33-34 were made with the processing conditions and percentages of fibers and binder material (on a dry weight basis), as shown in TABLE 3.

TABLE 3

| | 2.5 | 7 | 18 | | Northern | | | | | | |
|---|---|---|---|---|---|---|---|---|---|---|---|
| | Micron | Micron | Micron | Nano- | Bleached | | | | | | |
| | 1.5 mm | 5 mm | 12 mm | fibrillated | Softwood | | Poly- | Styrene | Acrylic | Cross- | Processing |
| | PET | PET | PET | Lyocell | Kraft | Eucalyptus | urethane | Butadiene | Latex | linker | Condition |
| Comp Ex 7 | 55.00 | | 7.00 | 10.00 | | | 13.30 | 13.30 | | 1.40 | Calendered |
| Comp Ex 8 | | 55.00 | 7.00 | 10.00 | | | 13.30 | 13.30 | | 1.40 | Calendered |
| Comp Ex 10 | | | | | 70.00 | | | | 30.00 | | Calendered |
| Example 19 | 30.00 | 25.00 | 7.00 | 10.00 | | | 13.30 | 13.30 | | 1.40 | Calendered |
| Example 20 | 30.00 | 25.00 | 7.00 | 10.00 | | | 13.30 | 13.30 | | 1.40 | Not |
| | | | | | | | | | | | Calendered |
| Example 21 | 41.00 | 35.00 | 10.00 | 14.00 | | | | | | | Calendered |
| Example 22 | 20.00 | 25.00 | 7.00 | 10.00 | | 10.00 | 13.30 | 13.30 | | 1.40 | Calendered |
| Example 23 | 20.00 | 25.00 | 7.00 | 10.00 | 10.00 | | 13.30 | 13.30 | | 1.40 | Calendered |
| Example 33 | 20.00 | | | | 50.00 | | | | 30.00 | | Not |
| | | | | | | | | | | | Calendered |
| Example 34 | 20.00 | | | | | 50.00 | | | 30.00 | | Not |
| | | | | | | | | | | | Calendered |

Comparative Examples 3-6 and Examples 1-18 and 24-32 are handsheets formed as follows. Any cellulosic based materials to be included in the handsheet were refined to 400 CSF, as needed. The cellulosic based materials were refined in either an 80 mm single disk at a plate clearance of 0.25 mm for approximately 30 minutes or a five-inch rotary refine under load for approximately five minutes. The test specimen was obtained by first determining the amount of fibers to weigh. For example, for a 100 g/m² handsheet produced with a 250 mm×300 mm Williams handsheet mold, a total of 7.5 grams of fibers and binder material (if any) (on a dry weight basis) were weighed. The fibers were then added to the pulper bowl of a two-liter TAPPI Standard pulper. 2000 mL of warm (80° F.-90°) water was also added to the pulper bowl, and the pulping cycle was initiated. The fibers and water were pulped for three minutes or 9000 revolutions. For additional dispersion, as needed, the fibers and water were pulped for an additional two minutes or 6000 revolutions.

Twenty liters of warm (80° F.-90°) water was then added to the handsheet mold, ensuring that the water line was above the wire screen. The pulped fibers and water were then poured into the handsheet mold. A stirrer plate was used to stroke the liquid three times vertically. The stirrer plate was then pulled diagonally to a corner and removed. After five seconds, the handsheet drop valve was pulled and the pulped fibers and water were allowed to drain, with the pulped fibers retained by the wire screen. The smooth side of a first sheet of 750 g/m² blotter paper was placed on the top of the handsheet formed on the wire screen. A couch roller was then used to flatten the formed handsheet onto the blotter paper. The wire screen with the formed handsheet was then raised; and the wire screen, with the formed handsheet and the first sheet of blotter paper, was inverted onto a second sheet of 750 g/m² blotter paper. After two minutes, the inverted screen was raised vertically, and the two sheets of blotter paper and the formed handsheet were horizontally peeled off the wire screen. The smooth sides of two sheets of 750 g/m2 blotter paper were stacked on the exposed top (without any sheets of blotter paper) of the formed handsheet, with the smooth side of each sheet of blotter paper facing the exposed top of the formed handsheet.

The formed handsheet with the two sheets of blotter paper on each of the top and bottom was placed in a felted Voith 20-ton wet press, pressed at 100 pounds force per square inch gauge for fifteen seconds and then pressed at 300 pounds force per square inch gauge for another fifteen seconds. The pressure was released, and the formed handsheet with the two sheets of blotter paper on each of the top and bottom was removed from the wet press.

The formed handsheet with the two sheets of blotter paper on each of the top and bottom was then placed in a 220-volt, 1400-watt Norwood handsheet dryer. The screen was locked and the formed handsheet with the two sheets of blotter paper on each of the top and bottom was dried at 235° F. for five minutes. One sheet of blotter paper was removed from each side of the formed handsheet. The formed handsheet with one sheet of blotter paper on each of the top and bottom was placed in a 110-volt, 1500-watt Williams handsheet dryer. The fabric was tightened, and the formed handsheet with the one sheet of blotter paper on each of the top and bottom was dried at 180° F for ten minutes.

For formed handsheets that were pre-densified (Examples 29-32), pre-densification occurred as follows. The one sheet of blotter paper on each of the top and bottom of the handsheet were removed from the handsheet. The formed handsheet was trimmed to a size 127 mm by 216 mm. A pilot calender from Wheeler Roll Company (Kalamazoo, Mich.) was used to pre-densify the handsheets. (This pilot calender is as described above.) The calender rolls were lightly engaged and the motor to turn the rolls was initiated. The heat guns were also initiated to heat the calender rolls to 90° C. After about two hours of heating time, the temperature of the calender rolls was verified with an Extech® Instruments Mini IR Thermometer (with an operating range of −50° C. to 380° C., calibrated to an emissivity of 0.95). Once the temperature of the calender rolls reached 90° C., the heat guns were deactivated; and the calender rolls were allowed to turn for about five minutes (to allow the calender rolls to reach equilibrium). The hydraulic lever was pumped until a pressure of 700 pounds force per square inch gauge (about 220 pounds force per lineal inch) was reached. The handsheet was then feed into the nip through the slot in the safety guard. The sheet was allowed to turn through the nip four times. The calender rolls were then stopped. The handsheet was removed from one of the calender rolls (to which it adhered lightly) with a small spatula.

After pre-densification, one sheet of 750 g/m² blotter paper was placed on each side (i.e., the top and bottom) of the pre-densified handsheet. Pre-densified handsheets with the one sheet of blotter paper on each of the top and bottom as well as non-pre-densified, formed handsheets still with the one sheet of blotter paper on each of the top and bottom were then placed in a forty-kilogram dry press for twelve to twenty-four hours. The sheets of blotter paper were then removed from the handsheet.

For formed handsheets with a binder material (Comparative Examples 3-6, Examples 1-9, 11-17, and 24-28 and pre-densified, trimmed Examples 29-32), the binding material was then added as follows. A powder-coated steel coating board (with dried latex layer) having greater than 45-dyne surface energy was used. One side of the formed handsheet was coated with binding material, and then the other side was coated with binding material. A similar procedure was used for coating each side of the formed handsheet.

Using a syringe, dilution water was added to the area on the steel coating board corresponding to he size of the handsheet, e.g., a 250 mm by 300 mm rectangle (for the handsheets that were not pre-densified_) or a 127 mm by 216 mm rectangle (for the handsheets that were pre-densified). Dilution water in an amount sufficient to fully but not excessively wet the first side of the handsheet was added to the steel coating board. For lower density (e.g., about 0.45 g/cm³), 250 mm by 300 mm size handsheets with a basis weight of 100 g/m², about 9 mL of dilution water was added for the first side; for lower density, 250 mm by 300 mm size handsheets with a basis weight of 80 g/m², about 8 mL of dilution water was added for the first side; for higher density (e.g., approximately 0.75 g/cm), pre-densified. 127 mm×216 mm handsheets, from about 0.3mL to about 1.0 mL dilution water was added for the first side.

Using a syringe, binding material in an amount based on the dry weight desired was added to the dilution water on the steel coating board. The amount of binding material added is a function of the density of the sheet. A lower density non-woven sheet generally requires a greater percentage of binding material than a higher density non-woven sheet. Binding material in a total amount up to about 40% by weight of the nonwoven sheet in its dry state is used to coat lower-density, non-pre-densified, 250 mm×300 mm handsheets; and binding material in a total amount up to about 10% by weight of the nonwoven sheet in its dry state is used to coat higher-density, pre-densified, 127 mm×216 mm handsheets. (A handsheet with a basis weight of 100 g/m² (prior to any trimming) requires a total of 7.5 grams of fibers, binding material and other materials (on a dry weight basis).) The total amount of binding material to be added was split, and fifty percent of the amount was added to the dilution water for the first side.

The dilution water and the binding material were then spread out to completely pool the correct-size area on the steel coating board. The handsheet was positioned over the correct size area and allowed to gently settle in the liquid to coat the first side. After 30-60 seconds of settling into the liquid, the handsheet was removed from the liquid.

Using a syringe, dilution water in an amount sufficient to fully but not excessively wet the second side of the handsheet was added to the correct size area on the steel coating board. For lower density, 250 mm by 300 mm size handsheets with a basis weight of 100 g/m², about 4 mL of dilution water was added for the second side: for lower density, 250 mm by 300 mm size handsheets with a basis weight of 80 g/m², about 3 mL of dilution water was added for the second side: for higher density, pre-densified, 127 mm×216 mm handsheets, from about 0.3 mL to about 1.0 mL dilution water was added for the second side. Using a syringe, the remaining fifty percent of the binding material was added to the dilution water for the second side on the steel coating board. The dilution water and the binding material were then spread out to completely pool the correct size area on the steel coating board. The handsheet was inverted, positioned over the correct size area and allowed to gently settle in the liquid to coat the second side. After 60-180 seconds of settling into the liquid, the handsheet was removed from the liquid. A 12 mm glass lab rod was used to roll the binding material into the handsheet interior, as needed.

The coated handsheet was then placed on a sheet of foil-backed release paper on a tray. The coated handsheet, the foil-backed release paper and the tray were placed in a 110-volt, 600-watt Excalibur® Convection Dehydrator at 145° F. for two minutes. The handsheet was then flipped and returned to the Excalibur® Convection Dehydrator at 145° F. After two minutes, the handsheet was transferred to a polycarbonate screen and returned to the Excalibur® Convection Dehydrator at 145° F. for four minutes. The handsheet was then flipped and returned to the Excalibur® Convection Dehydrator at 145° F. for an additional four minutes. The handsheet was then removed from the Excalibur® Convection Dehydrator, and a sheet of foil-backed release paper was placed on each side (i.e., the top and bottom) of the handsheet. The handsheet with a sheet of foil-backed release paper on each of the top and bottom was then placed in a 220-volt, 1400-watt Norwood handsheet dryer. The screen was locked and the handsheet with a sheet of foil-backed release paper on each of the top and bottom was dried at 235° F. for four minutes.

For dried handsheets that were calendered (Comparative Examples 3-6 and Examples 1-8, 10-16, 18 and 24-32), calendering occurred as follows. Any handsheets not yet trimmed to 127 mm by 216 mm were trimmed to that size. A pilot calender from Wheeler Roll Company (Kalamazoo, Mich.) was used to calender the handsheets. (This pilot calender is as described above.) The calender rolls were lightly engaged and the motor to turn the rolls was initiated. The heat guns were also initiated to heat the calender rolls to 90° C. After about two hours of heating time, the temperature of the calender rolls was verified with an Extech® Instruments Mini IR Thermometer (with an operating range of −50° C. to 380° C., calibrated to an emissivity of 0.95). Once the temperature of the calender rolls reached 90° C., the heat guns were deactivated; and the calender rolls were allowed to turn for about five minutes (to allow the calender rolls to reach equilibrium). The hydraulic lever was pumped until a pressure of 700 pounds force per square inch gauge (about 220 pounds force per lineal inch) was reached. The handsheet was then feed into the nip through the slot in the safety guard. The sheet was allowed to turn through the nip four times. The calender rolls were then stopped. The handsheet was removed from one of the calender rolls (to which it adhered lightly) with a small spatula.

Following the above procedure, handsheets for Comparative Examples 3-6 and Examples 1-18 and 24-32 were made with the processing conditions and percentages of fibers and binder material (on a dry weight basis), as shown in TABLE 4.

TABLE 4

| | 2.5 | 7 | 18 | 14 | 17 | | | | | | | | |
|---|---|---|---|---|---|---|---|---|---|---|---|---|---|
| | Micron | Micron | Micron | Micron | Micron | Nano- | | | Poly- | Styrene | Poly- | | |
| | 1.5 mm | 5 mm | 12 mm | 10 mm | 10 mm | fibrillated | | | ure- | Buta- | vinyl | Cross- | Processing |
| | PET | PET | PET | PET | PET | Lyocell | Eucalyptus | Cotton | thane | diene | Acetate | linker | Condition |
| Comp Ex 3 | 23.72 | | 10.05 | | | 15.29 | 15.29 | 7.65 | 13.30 | 13.44 | | 1.26 | Calendered |
| Comp Ex 4 | | 31.74 | 8.38 | | | 12.75 | 12.75 | 6.38 | 13.30 | 13.44 | | 1.26 | Calendered |
| Comp Ex 5 | 32.90 | | 13.15 | | | 25.95 | | | 13.30 | | 13.44 | 1.26 | Calendered |
| Comp Ex 6 | | 41.30 | 10.34 | | | 20.36 | | | 13.30 | | 13.44 | 1.26 | Calendered |
| Example 1 | 15.53 | 24.90 | 6.57 | | | 10.00 | 10.00 | 5.00 | 13.30 | 13.44 | | 1.26 | Calendered |
| Example 2 | 17.08 | 27.42 | | | | 11.00 | 11.00 | 5.50 | 13.30 | 13.44 | | 1.26 | Calendered |
| Example 3 | 18.03 | 28.93 | 7.62 | | | | 11.61 | 5.81 | 13.30 | 13.44 | | 1.26 | Calendered |
| Example 4 | 15.53 | 24.90 | 6.57 | | | 10.00 | 10.00 | 5.00 | 26.74 | | | 1.26 | Calendered |
| Example 5 | 15.53 | 24.90 | 6.57 | | | 10.00 | 10.00 | 5.00 | | 26.74 | | 1.26 | Calendered |
| Example 6 | 15.53 | 24.90 | 6.57 | | | 10.00 | 10.00 | 5.00 | 14.00 | 14.00 | | | Calendered |
| Example 7 | 18.03 | 28.92 | 7.63 | | | 11.61 | | 5.81 | 13.30 | 13.44 | | 1.26 | Calendered |
| Example 8 | 16.69 | 26.75 | 7.06 | | | 10.75 | 10.75 | | 13.30 | 13.44 | | 1.26 | Calendered |
| Example 9 | 15.53 | 24.90 | 6.57 | | | 10.00 | 10.00 | 5.00 | 13.30 | 13.44 | | 1.26 | Not Calendered |
| Example 10 | 21.57 | 34.57 | 9.13 | | | 13.89 | 13.89 | 6.95 | | | | | Calendered |
| Example 11 | 19.00 | 30.40 | 7.60 | | | 15.00 | | | 13.30 | | 13.44 | 1.26 | Calendered |
| Example 12 | 21.20 | 34.00 | | | | 16.80 | | | 13.30 | | 13.44 | 1.26 | Calendered |
| Example 13 | 24.00 | 38.40 | 9.60 | | | | | | 13.30 | | 13.44 | 1.26 | Calendered |
| Example 14 | 19.00 | 30.40 | 7.60 | | | 15.00 | | | 26.74 | | | 1.26 | Calendered |
| Example 15 | 19.00 | 30.40 | 7.60 | | | 15.00 | | | | | 26.74 | 1.26 | Calendered |
| Example 16 | 19.00 | 30.40 | 7.60 | | | 15.00 | | | 14.00 | | 14.00 | | Calendered |
| Example 17 | 19.00 | 30.40 | 7.60 | | | 15.00 | | | 13.30 | | 13.44 | 1.26 | Not Calendered |
| Example 18 | 26.39 | 42.21 | 10.56 | | | 20.84 | | | | | | | Calendered |
| Example 24 | 19.00 | 38.00 | 5.00 | | | 10.00 | | | 13.30 | 13.44 | | 1.26 | Calendered |
| Example 25 | 14.00 | 41.83 | 5.38 | | | 10.79 | | | 13.30 | 13.44 | | 1.26 | Calendered |
| Example 26 | 9.00 | 45.57 | 5.50 | | | 11.93 | | | 13.30 | 13.44 | | 1.26 | Calendered |
| Example 27 | 24.00 | 34.41 | 4.53 | | | 9.06 | | | 13.30 | 13.44 | | 1.26 | Calendered |
| Example 28 | 29.00 | 30.83 | 4.06 | | | 8.11 | | | 13.30 | 13.44 | | 1.26 | Calendered |
| Example 29 | 17.50 | 49.75 | 11.75 | | | 6.00 | | | 7.15 | 7.15 | | 0.70 | Pre-densified |
| | | | | | | | | | | | | | & Calendered |
| Example 30 | 17.50 | 49.75 | 11.75 | | | 6.00 | | | 7.15 | 7.15 | | 0.70 | Pre-densified |
| | | | | | | | | | | | | | & Calendered |
| Example 31 | 17.50 | 49.75 | | 11.75 | | 6.00 | | | 7.15 | 7.15 | | 0.70 | Pre-densified |
| | | | | | | | | | | | | | & Calendered |
| Example 32 | 17.50 | 49.75 | | | 11.75 | 6.00 | | | 7.15 | 7.15 | | 0.70 | Pre-densified |
| | | | | | | | | | | | | | & Calendered |

Comparative Examples 1-10 and Examples 1-34 were tested for various properties. Properties measured include the properties described below, with reference to a test method and/or standard. Each test method or standard referenced below is dated 1993 or later, and each test method or standard referenced below is incorporated in its entirety in this application by this reference.

Basis Weight is the weight (or, more properly, mass) per unit area. It is expressed as grams per square meter (gsm or g/m²) and was measured in accordance with TAPPI Test Method T 410, “Grammage of Paper and Paperboard (Weight per Unit Area).”

Air Permeability (or Porosity) is the flow of air (cm³/min) passing through 1 cm² surface of a test piece at a measuring pressure of 1.00 kPa. It is expressed in Coresta Units and was measured in accordance with Coresta Recommended Method N° 40, “Determination of Air Permeability of Materials Used As Cigarette Papers, Filter Plug Wrap and Filter Joining Paper Including Materials Having an Oriented Permeable Zone.” This method was the predecessor to ISO Standard 2965, “Materials Used As Cigarette Papers, Filter Plug Wrap and Filter Joining Paper, Including Materials Having an Oriented Permeable Zone—Determination of Air Permeability” issued in 1997.

Formation (or Uniformity) is the indicator of the variation within the sheet, i.e., how uniformly the fibers are distributed in a sheet and the amount of flocculation that has occurred. Several paper properties, including but not limited to opacity and strength properties, depend on formation, as a poorly formed sheet has more weak and thin and/or thick spots. Generally, there is no standard method or unit to express formation. Formation is usually determined by visual, subjective inspection followed by a relative ranking of the formation/uniformity of the sheet on a scale of 1 to 5, as shown in TABLE 5.

TABLE 5

| Visual Inspection of | Relative Ranking of |
|---|---|
| Formation/Uniformity | Formation/Uniformity |
| Highly Variable | 5.0 |
| Variable | 4.0 |
| Almost Uniform | 3.0 |
| Uniform | 2.0 |
| Very Uniform | 1.0 |

To eliminate subjectivity relative to formation/uniformity, for the present application formation/uniformity was determined based on opacity. Specifically, the opacity percent of a handsheet was measured using a Thwing-Albert Digital Opacity Gauge operated in accordance with TAPPI Test Method T 425, “Opacity of Paper (15/d Geometry, Illuminant A/2°, 89% Reflectance Backing and Paper Backing).” The aperture size of the Thwing-Albert Digital Opacity Gauge is 415 mm² (based on a 23 mm diameter aperture). However, most formation/uniformity variability occurs in an area much smaller than 415 mm². Therefore, for the comparative example and example handsheets, an aperture mask was used to reduce the aperture size to 16 mm², a 4 mm×4 mm square. The opacity percent of a handsheet was measured, and the standard deviation of numerous (at least ten) measured opacity percent values was determined. The standard deviation of the set of opacity percent values was then multiplied by 1000, for an objective measurement and definition of formation/uniformity (with a higher number meaning poorer formation). The objective measurements of formation/uniformity were determined to correspond to the subjective, relative rankings (as discussed above) at the formation/uniformity measurements shown in TABLE 6.

TABLE 6

| Visual Inspection | | Objective Measurement of |
|---|---|---|
| of Formation/ | Relative Ranking of | Formation/Uniformity |
| Uniformity | Formation/Uniformity | (Std. Dev. Opacity % × 1000) |
| Highly Variable | 5.0 | 1190 |
| Variable | 4.0 | 1010 |
| Almost Uniform | 3.0 | 557 |
| Uniform | 2.0 | 388 |
| Very Uniform | 1.0 | 236 |

Log Reduction Value is the ability of a porous packaging material to resist passage of microorganisms. It is expressed as a simple number and was measured in accordance with ASTM Standard F1608, “Standard Test Method for Microbial Ranking of Porous Packaging Materials (Exposure Chamber Method).”

Bacterial Filtration Efficiency (BFE) is the effectiveness of a material in preventing the passage of bacteria. It is expressed as a percentage of a known quantity of bacteria that does not pass through the material. It was measured based on ASTM Standard F2101, “Standard Test Method for Evaluating the Bacterial Filtration Efficiency (BFE) of Medical Face Mask Materials, Using a Biological Aerosol of Staphylococcus aureus,” with the exceptions that the materials were handsheets instead of medical face mask materials and that the maximum filtration efficiency determinable exceed 99.9%.

Bursting Strength is the maximum hydrostatic pressure required to produce rupture of a material. It is expressed as pounds force per square inch gauge and was measured based on TAPPI Test Method T 403, “Bursting Strength of Paper,” with the exception that, to measure the higher bursting strengths, a Mullen A Burst Tester (designed to provide pressure readings up to 1500 pounds force per square inch) was used instead of a Mullen C Burst Tester (designed to provide pressure readings up to 200 pounds force per square inch).

Internal Tearing Resistance is the ability of a sheet to withstand a tearing force to which it is subjected. It is expressed in grams and was measured based on TAPPI Test Method T 414, “Internal Tearing Resistance of Paper (Elmendorf-Type Method),” with the exception that the comparative example and example handsheets were cut straight on three sides and cut curved (i.e., half-moon shaped) on the fourth side. Also, for Comparative Examples 1, 2 and 9, internal tearing resistance in the machine direction and internal tearing resistance in the cross direction were both measured. For these comparative examples, the internal tearing resistance reported in the table below is the average internal tearing resistance, which is defined as the average of the internal tearing resistance in the machine direction and the internal tearing resistance in the cross direction. Comparative Examples 3-6 and Examples 1-18 and 24-28 are non-directional handsheets, without a machine direction or a cross direction. For these, the internal tearing resistance reported in the table below is internal tearing resistance measured in one direction.

Slow Rate Penetration Resistance is the ability of a sheet to withstand elongation and/or puncture by a driven probe. It is expressed in Newtons and was measured based on ASTM Standard F1306-, “Standard Test Method for Slow Rate Penetration Resistance of Flexible Barrier Films and Laminates,” with the exception that the sample size used was no more than 3.5 inches in width with a varying length instead of three inches by three inches.

Tensile Strength is the maximum tensile force that develops in a sheet before rupture. It is the force per unit width of a test material and is expressed in kilograms per fifteen millimeters. It was measured based on TAPPI Test Method T 494, “Tensile Properties of Paper and Paperboard (Using Constant Rate of Elongation Apparatus),” with the exception that the sample size used was 30 mm wide instead of 25 mm±1 mm. Also, for Comparative Examples 1, 2 and 9, tensile strength in the machine direction and tensile strength in the cross direction were both measured. For these comparative examples, the tensile strength reported in the table below is the average tensile strength, which is defined as the average of the tensile strength in the machine direction and the tensile strength in the cross direction. Comparative Examples 3-8 and 10 and Examples 1-19 and 21-34 are non-directional handsheets, without a machine direction or a cross direction. For these, the tensile strength reported in the table below is tensile strength measured in one direction.

Stretch is the amount of distortion a sheet undergoes under tensile force. It is expressed as a percentage (i.e., one hundred times the ratio of the increase in length of the sheet to the original test span) and was measured based on TAPPI Test Method T 494, “Tensile Properties of Paper and Paperboard (Using Constant Rate of Elongation Apparatus),” with the exception that the sample size used was 30 mm wide instead of 25 mm +1 mm. Also, for Comparative Examples 1, 2 and 9, stretch in the machine direction and stretch in the cross direction were both measured. For these comparative examples, the stretch reported in the table below is the average stretch, which is defined as the average of the stretch in the machine direction and the stretch in the cross direction. Comparative Examples 3-8 and 10 and Examples 1-19 and 21-34 are non-directional handsheets, without a machine direction or a cross direction. For these, the stretch reported in the table below is stretch measured in one direction.

The measured values of various properties of Comparative Examples 1-10 and Examples 1-34 are reported in TABLE 7. With the exception of Formation (explained above) and basis weight (with only one measurement), each value is an average of numerous (at least three and up to twenty) measurements. (The open, or blank, squares indicate that a particular property was not determined for that particular comparative example or example.)

TABLE 7

| | | | | | | | Internal | | | |
|---|---|---|---|---|---|---|---|---|---|---|
| | | | Formation | | | | Tearing | | Tensile | |
| | | Air | (Std. Dev. | Log | Bacterial | | Resistance | Slow Rate | Strength | Stretch |
| | Basis | Permeability | Opacity | Reduction | Filtration | Bursting | (Ave MD | Penetration | (Ave MD | (Ave MD |
| | Weight | (Corresta | % × | Value | Efficiency | Strength | & CD) | Resistance | & CD) | & CD) |
| | (gsm) | Units) | 1000) | (number) | (%) | (psig) | (g) | (N) | (kg/15 mm) | (%) |
| Comp Ex 1 | 74.60 | 102.60 | 1484.05 | 5.23 | 98.910000 | 165.35 | 361.00 | 69.74 | 9.61 | 19.45 |
| Comp Ex 2 | 60.00 | 91.70 | 1238.11 | 5.20 | 99.984000 | 108.60 | 317.20 | 49.80 | 7.54 | 16.90 |
| Comp Ex 3 | 97.00 | 97.00 | 537.90 | | | 74.00 | 264.00 | 25.02 | 6.98 | 10.75 |
| Comp Ex 4 | 99.00 | 121.00 | 264.37 | | | 113.75 | 317.33 | 41.54 | 8.20 | 10.00 |
| Comp Ex 5 | 99.00 | 72.00 | 217.05 | | | 98.25 | 341.33 | 32.84 | 6.53 | 20.00 |
| Comp Ex 6 | 97.00 | 107.00 | 535.41 | | | 164.25 | 392.00 | 49.41 | 9.10 | 17.25 |
| Comp Ex 7 | 101.00 | 80.00 | 953.00 | 3.60 | 99.999983 | 61.00 | | | 5.20 | 19.00 |
| Comp Ex 8 | 101.00 | 256.00 | 1026.00 | 1.50 | 99.660000 | 125.00 | | | 8.00 | 11.00 |
| Example 1 | 99.00 | 140.00 | 496.66 | | | 105.25 | 293.33 | 37.89 | 7.43 | 11.25 |
| Example 2 | 99.00 | 114.00 | 544.00 | | | 92.25 | 192.00 | 34.21 | 7.58 | 10.25 |
| Example 3 | 99.00 | 248.00 | 460.56 | | | 98.00 | 338.67 | 40.69 | 7.50 | 13.50 |
| Example 4 | 100.00 | 137.00 | 402.91 | | | 105.50 | 258.67 | 34.51 | 8.45 | 12.50 |
| Example 5 | 97.00 | 151.00 | 241.29 | | | 82.25 | 272.00 | 27.27 | 7.83 | 9.00 |
| Example 6 | 99.00 | 134.00 | 453.26 | | | 118.75 | 274.67 | 40.00 | 7.83 | 11.75 |
| Example 7 | 97.00 | 143.00 | 371.93 | | | 100.25 | 306.67 | 40.15 | 7.93 | 12.25 |
| Example 8 | 97.00 | 153.00 | 672.39 | | | 95.75 | 344.00 | 40.92 | 8.55 | 12.25 |
| Example 9 | 97.00 | 358.00 | 105.93 | | | 96.25 | 309.33 | 40.50 | 8.18 | 10.75 |
| Example 10 | 95.00 | 122.00 | 149.44 | | | 33.00 | 330.67 | 21.51 | 2.78 | 5.25 |
| Example 11 | 97.00 | 116.00 | 319.03 | | | 138.25 | 328.00 | 47.39 | 8.56 | 16.00 |
| Example 12 | 100.00 | 101.00 | 312.87 | | | 133.00 | 186.67 | 41.30 | 9.40 | 16.50 |
| Example 13 | 99.00 | 696.00 | 394.97 | | | 149.75 | 444.00 | 46.79 | 7.80 | 19.50 |
| Example 14 | 99.00 | 118.00 | 600.83 | | | 139.50 | 362.67 | 43.42 | 8.43 | 15.25 |
| Example 15 | 100.00 | 110.00 | 231.18 | | | 118.25 | 317.33 | 49.75 | 7.25 | 21.25 |
| Example 16 | 100.00 | 116.00 | 366.52 | | | 130.00 | 333.33 | 44.54 | 8.75 | 20.50 |
| Example 17 | 100.00 | 216.00 | 211.08 | | | 128.50 | 338.00 | 45.66 | 8.91 | 19.25 |
| Example 18 | 99.00 | 113.00 | 193.65 | | | 54.25 | 392.00 | 19.46 | 3.53 | 10.00 |
| Example 19 | 101.00 | 100.00 | 300.00 | 4.20 | 99.999210 | 74.00 | | | 7.10 | 12.00 |
| Example 20 | | | | 1.20 | 99.890000 | | | | | |
| Example 21 | 91.00 | 116.00 | 1241.00 | 1.80 | 99.999983 | 33.00 | | | 2.20 | 8.00 |
| Example 22 | 101.00 | 116.00 | 432.00 | 3.00 | 99.999370 | 86.00 | | | 6.30 | 11.00 |
| Example 23 | 101.00 | 124.00 | 559.00 | 2.90 | 99.998900 | 102.00 | | | 6.80 | 10.00 |
| Example 24 | 99.00 | 183.00 | 206.83 | | | 126.25 | 324.00 | 43.10 | 9.08 | 14.25 |
| Example 25 | 99.00 | 246.00 | 325.92 | | | 132.25 | 322.67 | 45.60 | 8.63 | 12.50 |
| Example 26 | 100.00 | 204.00 | 249.67 | | | 130.75 | 333.71 | 44.33 | 9.75 | 12.50 |
| Example 27 | 100.00 | 181.00 | 408.25 | | | 116.25 | 330.67 | 42.68 | 7.88 | 14.25 |
| Example 28 | 99.00 | 200.00 | 359.17 | | | 103.50 | 298.67 | 42.04 | 8.55 | 14.00 |
| Example 29 | 106.00 | 106.00 | 544.00 | | | 185.00 | | | 15.60 | 18.00 |
| Example 30 | 88.00 | 136.00 | 455.00 | | | 157.00 | | | 10.80 | 17.00 |
| Example 31 | 106.00 | 108.00 | 401.00 | | | 202.00 | | | 12.50 | 20.00 |
| Example 32 | 106.00 | 124.00 | 320.00 | | | 198.00 | | | 13.40 | 19.00 |
| Comp Ex 9 | 85.00 | 130.00 | 185.00 | 1.23 | 99.520000 | 36.00 | 97.00 | 14.46 | 7.10 | 6.70 |
| Comp Ex 10 | 101.00 | 128.00 | 822.00 | 1.10 | 99.810000 | 76.00 | | | 7.00 | 13.00 |
| Example 33 | 96.00 | 276.00 | 525.00 | 0.60 | 99.000000 | 32.00 | | | 3.60 | 11.00 |
| Example 34 | 86.00 | 472.00 | 505.00 | 0.50 | 98.200000 | 16.00 | | | 1.70 | 15.00 |

First non-cellulosic polymeric fibers contribute to improved air permeability and improved bacterial filtration efficiency. Second non-cellulosic polymeric fibers contribute to improved strength properties such as bursting strength, internal tear resistance, slow rate penetration resistance, tensile strength and stretch. Surprisingly, combining first non-cellulosic polymeric fibers and second non-cellulosic polymeric fibers generally contributes to improved formation.

The above description and examples and embodiments disclosed in EXAMPLES—SET I, EXAMPLES—SET II and otherwise are illustrative only and should not be interpreted as limiting. The present invention includes the description and the examples and embodiments disclosed but it is not limited to such description, examples and embodiments. Modifications and other embodiments will be apparent to those skilled in the art, and all such modifications and other embodiments are intended and deemed to be within the scope of the present invention as defined by the claims.

What is claimed is as follows:

1. A hydraulically-formed nonwoven sheet comprising
a. first non-cellulosic polymeric fibers in an amount of from about 5% to about 90% by weight of the nonwoven sheet in its dry state, wherein the first non-cellulosic polymeric fibers have an average diameter less than about 3.5 micron, an average cut length less than about 3 millimeters and an average aspect ratio of about 400 to about 2000, and
b. second non-cellulosic polymeric fibers in an amount of from about 10% to about 95% by weight of the nonwoven sheet in its dry state, wherein the second non-cellulosic polymeric fibers have an average diameter greater than about 3.5 micron and an average aspect ratio of about 400 to about 1000.

2. The nonwoven sheet of claim 1 wherein the first non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

3. The nonwoven sheet of claim 1 wherein the first non-cellulosic polymeric fibers comprise polyester.

4. The nonwoven sheet of claim 1 wherein the second non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

5. The nonwoven sheet of claim 1 wherein the second non-cellulosic polymeric fibers comprise polyester.

6. The nonwoven sheet of claim 1 further comprising third non-cellulosic polymeric fibers in an amount up to about 50% by weight of the nonwoven sheet in its dry state, wherein the third non-cellulosic polymeric fibers have an average diameter greater than about 10 microns and an average cut length greater than about 5 millimeters.

7. The nonwoven sheet of claim 6 wherein the third non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

8. The nonwoven sheet of claim 6 wherein the third non-cellulosic polymeric fibers comprise polyester.

9. The nonwoven sheet of claim 6 wherein the first non-cellulosic polymeric fibers, the second non-cellulosic polymeric fibers and the third non-cellulosic polymeric fibers are oriented.

10. The nonwoven sheet of claim 1 wherein the total weight of all non-cellulosic polymeric fibers comprising the nonwoven sheet comprises at least about 35% by weight of the nonwoven sheet in its dry state.

11. The nonwoven sheet of claim 1 wherein the nonwoven sheet has a wet process tensile strength of at least about 100 grams/30 millimeters.

12. The nonwoven sheet of claim 1 further comprising cellulosic based materials in an amount up to about 75% by weight of the nonwoven sheet in its dry state, wherein the cellulosic based materials comprise fibers manufactured from cellulose; naturally occurring cellulosic materials selected from hardwood fibers, softwood fibers, non-wood fibers or blends thereof; or blends of fibers manufactured from cellulose and naturally occurring cellulosic materials.

13. The nonwoven sheet of claim 12 wherein the fibers manufactured from cellulose are nano-fibrillated.

14. The nonwoven sheet of claim 1 further comprising binding material in an amount up to about 40% by weight of the nonwoven sheet in its dry state.

15. The nonwoven sheet of claim 14 wherein the binding material comprises acrylic latex, styrene butadiene copolymer, butadiene acrylonitrile copolymer, polyurethane, polyvinyl acetate, polyvinyl alcohol, natural rubber or other nature-based adhesive, polyvinyl chloride, polychloroprene, epoxy, phenol, urea-formaldehyde, thermal melt adhesive, surface treatment material, surface treatment method, binder fiber, crosslinking agent, tackifier or blends thereof.

16. The nonwoven sheet of claim 14 wherein the binding material comprises styrene butadiene copolymer, polyurethane and crosslinking agent.

17. The nonwoven sheet of claim 14 wherein the binding material comprises polyvinyl acetate, polyurethane and crosslinking agent.

18. The nonwoven sheet of claim 1 wherein the nonwoven sheet comprises multiple layers.

19. The nonwoven sheet of claim 18 wherein a first layer comprises the first non-cellulosic polymeric fibers and a second layer comprises the second non-cellulosic polymeric fibers.

20. The nonwoven sheet of claim 18 wherein at least one of the multiple layers comprises a scrim material.

21. The nonwoven sheet of claim 1 wherein the nonwoven sheet has a basis weight of from about 15 grams/meter² to about 250 grams/meter².

22. The nonwoven sheet of claim 21 wherein the basis weight is from about 50 grams/meter² to about 100 grams/meter².

23. The nonwoven sheet of claim 1 wherein the nonwoven sheet has an air permeability of at least about 90 Coresta units.

24. The nonwoven sheet of claim 22 wherein the nonwoven sheet has an air permeability of at least about 100 Coresta units.

25. The nonwoven sheet of claim 1 wherein the nonwoven sheet has a formation of about 1000 or less.

26. The nonwoven sheet of claim 22 wherein the nonwoven sheet has a formation of about 500 or less.

27. The nonwoven sheet of claim 1 wherein the nonwoven sheet is a porous packaging material having a log reduction value of at least about 2.

28. The nonwoven sheet of claim 22 wherein the nonwoven sheet is a porous packaging material having a log reduction value of at least about 3.

29. The nonwoven sheet of claim 1 wherein the nonwoven sheet has a bacterial filtration efficiency of at least about 94%

30. The nonwoven sheet of claim 22 wherein the nonwoven sheet has a bacterial filtration efficiency of at least about 99%.

31. The nonwoven sheet of claim 1 wherein the nonwoven sheet has a bursting strength of at least about 75 pounds force per square inch gauge.

32. The nonwoven sheet of claim 22 wherein the nonwoven sheet has a bursting strength of at least about 120 pounds force per square inch gauge.

33. The nonwoven sheet of claim 1 wherein the nonwoven sheet has an average internal tearing resistance of at least about 150 grams.

34. The nonwoven sheet of claim 22 wherein the nonwoven sheet has an average internal tearing resistance of at least about 275 grams.

35. The nonwoven sheet of claim 1 wherein the nonwoven sheet has a slow rate penetration resistance of at least about 25 Newtons.

36. The nonwoven sheet of claim 22 wherein the nonwoven sheet has a slow rate penetration resistance of at least about 40 Newtons.

37. The nonwoven sheet of claim 1 wherein the nonwoven sheet has an average tensile strength of at least about 6 kilograms/15 millimeters.

38. The nonwoven sheet of claim 22 wherein the nonwoven sheet has an average tensile strength of at least about 7 kilograms/15 millimeters.

39. The nonwoven sheet of claim 1 wherein the nonwoven sheet has an average stretch of at least about 7%.

40 The nonwoven sheet of claim 22 wherein the nonwoven sheet has an average stretch of at least about 11%.

41. The nonwoven sheet of claim 1 wherein the nonwoven sheet is printed.

42. The nonwoven sheet of claim 1 wherein the nonwoven sheet maintains dimensional stability when exposed to temperatures up to about 200° C.

43. A package for an article wherein the package comprises the nonwoven sheet of claim 1.

44. The package of claim 43 further comprising at least one additional layer directly adhered to the nonwoven sheet, wherein the additional layer comprises a second hydraulically-formed nonwoven sheet, paper, thermoplastic material, binding material, coating material or a combination thereof.

45. The package of claim 43 wherein the nonwoven sheet is directly adhered to itself.

46. The package of claim 43 wherein the nonwoven sheet is thermoformed.

47. The package of claim 43 wherein the nonwoven sheet is attached to a thermoformed container.

48. The package of claim 43 wherein the article comprises a medical device.

49. The package of claim 43 wherein the article comprises desiccant.

50. A method of packaging a medical device comprising
a. providing a package, wherein the package comprises the nonwoven sheet of claim 1;
b. placing a medical device in the package;
c. enclosing the medical device in the package by forming a continuous closing seal, whereby a sealed package is formed; and
d. introducing a sterilizing gas into the sealed package through the nonwoven sheet.

51. The method of claim 50 wherein forming the continuous closing seal comprises heat sealing, weld sealing, ultrasonic sealing, adhesive sealing or a combination thereof.

52. The method of claim 51 wherein heat sealing is accomplished with a seal time of at least about 0.5 seconds, an upper jaw seal temperature of at least about 120° C. and a seal pressure of at least about 40 pounds force per square inch.

53. The method of claim 52 wherein the upper jaw seal temperature is from about 180° C. to about 200° C.

54. The method of claim 51 wherein, after heat sealing to form a sealed package, the nonwoven sheet has an air permeability of at least about 100 Coresta units, a bacterial filtration efficiency of at least about 99%, a bursting strength of at least about 120 pounds force per square inch gauge, an average internal tearing resistance of at least about 275 grams, a slow rate penetration resistance of at least about 40 Newtons and an average tensile strength of at least about 7 kilograms/15 millimeters.

55. The method of claim 50 wherein the sterilizing gas comprises dry heat, steam, ethylene oxide or a combination thereof.

56. The method of claim 55 further comprising removing the ethylene oxide from the package by flushing the package with an inert gas, applying a vacuum to the package or a combination thereof.

57. A method of manufacturing a nonwoven sheet comprising the sequential steps of
a. adding materials to a hydropulper, wherein the materials comprise
(1) water;
(2) first non-cellulosic polymeric fibers in an amount of from about 5% to about 90% by weight of the nonwoven sheet in its dry state, wherein the first non-cellulosic polymeric fibers have an average diameter less than about 3.5 micron, an average cut length less than about 3 millimeters and an average aspect ratio of about 400 to about 2000; and
(3) second non-cellulosic polymeric fibers in an amount of from about 10% to about 95% by weight of the nonwoven sheet in its dry state, wherein the second non-cellulosic polymeric fibers have an average diameter greater than about 3.5 micron and an average aspect ratio of about 400 to about 1000;
b. agitating the materials added to the hydropulper to form a furnish;
c. delivering the furnish from the hydropulper to holding means;
d. delivering the furnish from the holding means to a forming section to form a web;
e. dewatering the web on the forming section;
f. couching the web to deliver the web to a pressing section;
g. pressing the web;
h. delivering the web to a drying section; and
i. drying the web.

58. The method of claim 57 wherein the first non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

59. The method of claim 57 wherein the first non-cellulosic polymeric fibers comprise polyester.

60. The method of claim 57 wherein the second non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

61. The method of claim 57 wherein the second non-cellulosic polymeric fibers comprise polyester.

62. The method of claim 57 wherein third non-cellulosic polymeric fibers in an amount up to 50% by weight of the nonwoven sheet in its dry state are added to the hydropulper, wherein the third non-cellulosic polymeric fibers have an average diameter greater than about 10 microns and an average cut length greater than about 5 millimeters.

63. The method of claim 62 wherein the third non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

64. The method of claim 62 wherein the third non-cellulosic polymeric fibers comprise polyester.

65. The method of claim 62 wherein the first non-cellulosic polymeric fibers, the second non-cellulosic polymeric fibers and the third non-cellulosic polymeric fibers are oriented.

66. The method of claim 57 wherein the total weight of all non-cellulosic polymeric fibers comprising the nonwoven sheet comprises at least about 35% by weight of the nonwoven sheet in its dry state.

67. The method of claim 57 wherein cellulosic based materials in an amount up to about 75% by weight of the nonwoven are added to the hydropulper, wherein the cellulosic based materials comprise fibers manufactured from cellulose; naturally occurring cellulosic materials selected from hardwood fibers, softwood fibers, non-wood fibers or blends therefore; or blends of fibers manufactured from cellulose and naturally occurring cellulosic materials.

68. The method of claim 67 wherein the fibers manufactured from cellulose are nano-fibrillated.

69. The method of claim 67 wherein the first non-cellulosic polymeric fibers, the second non-cellulosic polymeric fibers and the cellulosic based materials are added to the hydropulper concurrently and agitated to form the furnish and wherein the furnish is delivered to holding means comprising a machine chest.

70. The method of claim 67 wherein the first non-cellulosic polymeric fibers and the second non-cellulosic polymeric fibers are added to the hydropulper and agitated to form a first furnish, wherein the first furnish is delivered to holding means comprising a blend chest delivering to a machine chest; the cellulosic based materials are added to the hydropulper and agitated to form a second furnish, wherein the second furnish is delivered to a refiner, refined and delivered to the holding means comprising the blend chest delivering to the machine chest; and the first furnish and the second furnish are blended in the blend chest and delivered to the machine chest prior to being delivered to the forming section.

71. The method of claim 57 wherein the first non-cellulosic polymeric fibers and the second non-cellulosic polymeric fibers are added to the hydropulper concurrently and agitated to form the furnish, and wherein the furnish is delivered to holding means comprising a machine chest.

72. The method of claim 57 wherein the first non-cellulosic polymeric fibers and the second non-cellulosic polymeric fibers are added to the hydropulper consecutively, whereby a first furnish and a second furnish is formed and wherein and the holding means comprises a first machine chest comprising the first furnish and a second machine chest comprising the second furnish.

73. The method of claim 57 wherein the web is formed through one or more headboxes, one or more slices or one or more cylinders.

74. The method of claim 57 wherein the forming section comprises a Fourdrinier, cylinder, rotoformer or inclined wire former.

75. The method of claim 57 wherein the web comprises multiple layers.

76. The method of claim 75 wherein a first layer comprises the first non-cellulosic polymeric fibers and a second layer comprises the second non-cellulosic polymeric fibers

77. The method of claim 75 wherein at least one of the multiple layers comprises a scrim material.

78. The method of claim 77 wherein the scrim material is added in the forming section, the pressing section or a combination thereof.

79. The method of claim 57 wherein the couched web delivered to the pressing section has a wet process tensile strength of at least about 100 grams/30 millimeters.

80. The method of claim 57 further comprising adding binding material in an amount up to about 40% by weight of the nonwoven sheet in its dry state

81. The method of claim 80 wherein adding binding material comprises adding binding material to the hydropulper.

82. The method of claim 80 wherein adding binding material comprises adding binding material to the furnish prior to the furnish being delivered to the forming section.

83. The method of claim 80 wherein adding binding material comprises adding binding material at an impregnator in the drying section.

84. The method of claim 80 wherein the binding material comprises acrylic latex, styrene butadiene copolymer, butadiene acrylonitrile copolymer, polyurethane, polyvinyl acetate, polyvinyl alcohol, natural rubber or other nature-based adhesive, polyvinyl chloride, polychloroprene, epoxy, phenol, urea-formaldehyde, thermal melt adhesive, surface treatment material, surface treatment method, binder fiber, crosslinking agent, tackifier or blends thereof.

85. The method of claim 80 wherein the binding material comprises styrene butadiene copolymer, polyurethane and crosslinking agent.

86. The method of claim 80 wherein the binding material comprises polyvinyl acetate, polyurethane and crosslinking agent.

87. The method of claim 57 further comprising pre-densifying the web.

88. The method of claim 87 wherein pre-densifying the web comprises using increased pressure in the pressing section, the drying section or a combination thereof.

89. The method of claim 88 wherein the increased pressure is from about 100 pounds force per lineal inch to about 1500 pounds force per lineal inch.

90. The method of claim 87 wherein pre-densifying the web comprises using a breaker stack in the drying section.

91. The method of claim 57 further comprising coating the web with a heat-sealable coating material at an impregnator in the drying section.

92. The method of claim 57 further comprising coating the web with a pressure-sensitive adhesive at an impregnator in the drying section.

93. The method of claim 57 further comprising calendering the web after drying the web.

94. The method of claim 93 wherein calendering occurs at a roll temperature of from about 65° C. to about 205° C. and a roll pressure of from about 100 pounds force per lineal inch to about 1500 pounds force per lineal inch.

95. The method of claim 93 wherein calendering bonds a scrim material to the web.

96. The method of claim 57 wherein the nonwoven sheet has a basis weight of from about 50 grams/meter² to about 100 grams/meter².

97. The method of claim 96 wherein the nonwoven sheet has an air permeability of at least about 100 Coresta units.

98. The method of claim 96 wherein the nonwoven sheet has a formation of about 500 or less.

99. The method of claim 96 wherein the nonwoven sheet is a porous packaging material having a log reduction value of at least about 3.

100. The method of claim 96 wherein the nonwoven sheet has a bacterial filtration efficiency of at least about 99%.

101. The method of claim 96 wherein the nonwoven sheet has a bursting strength of at least about 120 pounds force per square inch gauge.

102. The method of claim 96 wherein the nonwoven sheet has an average internal tearing resistance of at least about 275 grams.

103. The method of claim 96 wherein the nonwoven sheet has a slow rate penetration resistance of at least about 40 Newtons.

104. The method of claim 96 wherein the nonwoven sheet has an average tensile strength of at least about 7 kilograms/15 millimeters.

105. The method of claim 96 wherein the nonwoven sheet has an average stretch of at least about 11%.

106. The method of claim 57 wherein the nonwoven sheet maintains dimensional stability when exposed to temperatures up to about 200° C.

107. A hydraulically-formed nonwoven sheet comprising
a. binding material in an amount of from about 5% to about 40% by weight of the nonwoven sheet in its dry state;
b. first non-cellulosic polymeric fibers in an amount of from about 10% to about 50% by weight of the nonwoven sheet in its dry state, wherein the first non-cellulosic polymeric fibers have an average diameter less than about 3.5 micron, an average cut length less than about 3 millimeters and an average aspect ratio of about 400 to about 2000;
c. second non-cellulosic polymeric fibers in an amount of from about 20% to about 65% by weight of the nonwoven sheet in its dry state, wherein the second non-cellulosic polymeric fibers have an average diameter greater than about 3.5 micron and an average aspect ratio of about 400 to about 1000;
d. third non-cellulosic polymeric fibers in an amount of from about 5% to about 30% by weight of the nonwoven sheet in its dry state, wherein the third non-cellulosic polymeric fibers have an average diameter greater than about 10 micron and an average cut length of greater than about 5 millimeters; and
e. cellulosic based materials in an amount of from about 5% to about 35% by weight of the nonwoven sheet in its dry state, wherein the cellulosic based materials comprise fibers manufactured from cellulose; naturally occurring cellulosic materials selected from hardwood fibers, softwood fibers, non-wood fibers or blends thereof; or blends of fibers manufactured from cellulose and naturally occurring cellulosic materials.

108. The nonwoven sheet of claim 107 wherein the binding material comprises acrylic latex, styrene butadiene copolymer, butadiene acrylonitrile copolymer, polyurethane, polyvinyl acetate, polyvinyl alcohol, natural rubber or other nature-based adhesive, polyvinyl chloride, polychloroprene, epoxy, phenol, urea-formaldehyde, thermal melt adhesive, surface treatment material, surface treatment method, binder fiber, crosslinking agent, tackifier or blends thereof.

109. The nonwoven sheet of claim 107 wherein the binding material comprises styrene butadiene copolymer, polyurethane and crosslinking agent.

110. The nonwoven sheet of claim 107 wherein the binding material comprises polyvinyl acetate, polyurethane and crosslinking agent.

111. The nonwoven sheet of claim 107 wherein the first non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

112. The nonwoven sheet of claim 107 wherein the first non-cellulosic polymeric fibers comprise polyester.

113. The nonwoven sheet of claim 107 wherein the second non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

114. The nonwoven sheet of claim 107 wherein the second non-cellulosic polymeric fibers comprise polyester.

115. The nonwoven sheet of claim 107 wherein the third non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

116. The nonwoven sheet of claim 107 wherein the third non-cellulosic polymeric fibers comprise polyester.

117. The nonwoven sheet of claim 107 wherein the fibers manufactured from cellulose are nano-fibrillated.

118. The nonwoven sheet of claim 107 wherein the first non-cellulosic polymeric fibers, the second non-cellulosic polymeric fibers and the third non-cellulosic polymeric material are oriented.

119. The nonwoven sheet of claim 107 wherein the nonwoven sheet comprises multiple layers.

120. The nonwoven sheet of claim 119 wherein a first layer comprises the first non-cellulosic polymeric fibers and a second layer comprises the second non-cellulosic polymeric fibers, the third non-cellulosic polymeric fibers or blends thereof.

121. The nonwoven sheet of claim 119 wherein at least one of the multiple layers comprises a scrim material.

122. The nonwoven sheet of claim 107 wherein the nonwoven sheet is produced by
a. adding materials to a hydropulper, wherein the materials comprise water, the first non-cellulosic polymeric fibers, the second non-cellulosic polymeric fibers, the third non-cellulosic polymeric fibers and the cellulosic based materials;
b. agitating the materials added to the hydropulper to form a furnish;
c. delivering the furnish from the hydropulper to holding means;
d. delivering the furnish from the holding means to a forming section to form a web;
e. dewatering the web on the forming section;
f. couching the web to deliver the web to a pressing section, wherein the couched web delivered to the pressing section has a wet process tensile strength of at least about 100 grams/30 millimeters;
g. pressing the web;
h. delivering the web to a drying section;
i. adding the binding material to the web at an impregnator in the drying section; and
j. drying the web.

123. The nonwoven sheet of claim 122 wherein the first non-cellulosic polymeric fibers, the second non-cellulosic polymeric fibers, the third non-cellulosic polymeric fibers and the cellulosic based materials are added to the hydropulper concurrently and agitated to form the furnish and wherein the furnish is delivered to holding means comprising a machine chest.

124. The nonwoven sheet of claim 122 wherein the first non-cellulosic polymeric fibers, the second non-cellulosic polymeric fibers and the third non-cellulosic polymeric fibers are added to the hydropulper and agitated to form a first furnish, wherein the first furnish is delivered to holding means comprising a blend chest delivering to a machine chest; the cellulosic based materials are added to the hydropulper and agitated to form a second furnish, wherein the second furnish is delivered to a refiner, refined and delivered to the holding means comprising the blend chest delivering to the machine chest; and the first furnish and the second furnish are blended in the blend chest and delivered to the machine chest prior to being delivered to the forming section.

125. The nonwoven sheet of claim 107 wherein the nonwoven sheet has a basis weight of from about 50 grams/meter² to about 100 grams/meter².

126. The nonwoven sheet of claim 125 wherein the nonwoven sheet has an air permeability of at least about 100 Coresta units.

127. The nonwoven sheet of claim 125 wherein the nonwoven sheet has a formation of about 500 or less.

128. The nonwoven sheet of claim 125 wherein the nonwoven sheet is a porous packaging material having a log reduction value of at least about 3.

129. The nonwoven sheet of claim 125 wherein the nonwoven sheet has a bacterial filtration efficiency of at least about 99%.

130. The nonwoven sheet of claim 125 wherein the nonwoven sheet has a bursting strength of at least about 120 pounds force per square inch gauge.

131. The nonwoven sheet of claim 125 wherein the nonwoven sheet has an average internal tearing resistance of at least about 275 grams.

132. The nonwoven sheet of claim 125 wherein the nonwoven sheet has a slow rate penetration resistance of at least about 40 Newtons.

133. The nonwoven sheet of claim 125 wherein the nonwoven sheet has an average tensile strength of at least about 7 kilograms/15 millimeters.

134. The nonwoven sheet of claim 125 wherein the nonwoven sheet has an average stretch of at least about 11%.

135. The nonwoven sheet of claim 107 wherein the nonwoven sheet maintains dimensional stability when exposed to temperatures up to about 200° C.

136. A hydraulically-formed nonwoven sheet comprising
a. binding material in an amount of about 5% to about 30% by weight of the nonwoven sheet in its dry state;
b. first polyester fibers in an amount of from about 10% to about 35% by weight of the nonwoven sheet in its dry state, wherein the first polyester fibers have an average diameter of about 2.5 micron and an average cut length of about 1.5 millimeters and wherein the first polyester fibers are oriented;
c. second polyester fibers in an amount of from about 25% to about 65% by weight of the nonwoven sheet in its dry state, wherein the second polyester fibers have an average diameter of about 7 microns and an average cut length of about 5 millimeters and wherein the second polyester fibers are oriented;
d. third polyester fibers in an amount of from about 5% to about 20% by weight of the nonwoven sheet in its dry state, wherein the third polyester fibers have an average diameter greater than about 10 micron and an average cut length of greater than about 5 millimeters and wherein the third polyester fibers are oriented;
e. fibers manufactured from cellulose in an amount of from about 5% to about 20% by weight of the nonwoven sheet in its dry state, wherein the fibers manufactured from cellulose are nano-fibrillated;
wherein the nonwoven sheet has a basis weight of from about 50 grams/meter² to about 100 grams/meter², an air permeability of at least about 100 Coresta units, a formation of about 500 or less, a bacterial filtration efficiency of at least about 99%, a bursting strength of at least about 120 pounds force per square inch gauge, an average internal tearing resistance of at least about 275 grams, a slow rate penetration resistance of at least about 40 Newtons, an average tensile strength of at least about 7 kilograms/15 millimeters and an average stretch of al least about 11%;
wherein the nonwoven sheet is a porous packaging material having a log reduction value of at least about 3; and
wherein the nonwoven sheet maintains dimensional stability when exposed to temperatures up to about 200° C.

137. The nonwoven sheet of claim 136 wherein the binding material comprises acrylic latex, styrene butadiene copolymer, butadiene acrylonitrile copolymer, polyurethane, polyvinyl acetate, polyvinyl alcohol, natural rubber or other nature-based adhesive, polyvinyl chloride, polychloroprene, epoxy, phenol, urea-formaldehyde, thermal melt adhesive, surface treatment material, surface treatment method, binder fiber, crosslinking agent, tackifier or blends thereof.

138. The nonwoven sheet of claim 136 wherein the binding material comprises styrene butadiene copolymer, polyurethane and crosslinking agent.

139. The nonwoven sheet of claim 136 wherein the binding material comprises polyvinyl acetate, polyurethane and crosslinking agent.

140. The nonwoven sheet of claim 136 wherein the nonwoven sheet comprises multiple layers.

141. The nonwoven sheet of claim 140 wherein a first layer comprises the first polyester fibers and a second layer comprises the second polyester fibers, the third polyester fibers or blends thereof.

142. The nonwoven sheet of claim 140 wherein at least one of the multiple layers comprises a scrim material.

143. The nonwoven sheet of claim 136 wherein the nonwoven sheet is produced by
a. adding materials to a hydropulper, wherein the materials comprise water, the first polyester fibers, the second polyester fibers, the third polyester fibers and the fibers manufactured from cellulose;
b. agitating the materials added to the hydropulper to form a furnish;
c. delivering the furnish from the hydropulper to a machine chest;
d. delivering the furnish from the machine chest to a forming section to form a web;
e. dewatering the web on the forming section;
f. couching the web to deliver the web to a pressing section, wherein the couched web delivered to the pressing section has a wet process tensile strength of at least about 100 grams/30 millimeters;
g. pressing the web;
h. delivering the web to a drying section;
i. adding the binding material to the web at an impregnator in the drying section; and
j. drying the web.

144. A hydraulically-formed nonwoven sheet comprising
a. binding material in an amount of from about 5% to about 40% by weight of the nonwoven sheet in its dry state;
b. non-cellulosic polymeric fibers in an amount of from about 5% to about 40% by weight of the nonwoven sheet in its dry state, wherein the non-cellulosic polymeric fibers have an average diameter less than about 3.5 micron, an average cut length less than about 3 millimeters and an average aspect ratio of about 400 to about 2000; and
c. cellulosic based materials in an amount of from about 45% to about 75% by weight of the nonwoven sheet in its dry state, wherein the cellulosic based materials comprise fibers manufactured from cellulose; naturally occurring cellulosic materials selected from hardwood fibers, softwood fibers, non-wood fibers or blends thereof; or blends of fibers manufactured from cellulose and naturally occurring cellulosic materials,
wherein the nonwoven sheet has a bacterial filtration efficiency of at least about 98%.

145. The nonwoven sheet of claim 144 wherein the binding material comprises acrylic latex, styrene butadiene copolymer, butadiene acrylonitrile copolymer, polyurethane, polyvinyl acetate, polyvinyl alcohol, natural rubber or other nature-based adhesive, polyvinyl chloride, polychloroprene, epoxy, phenol, urea-formaldehyde, thermal melt adhesive, surface treatment material, surface treatment method, binder fiber, crosslinking agent, tackifier or blends thereof.

146. The nonwoven sheet of claim 144 wherein the non-cellulosic polymeric fibers comprise polyolefin, polyester, polyamide, polylactide, polycaprolactone, polycarbonate, polyurethane, polyvinyl acetate, polyvinyl chloride, polyvinyl alcohol, polyacrylate or polyacrylonitrile, ionomer or blends thereof.

147. The nonwoven sheet of claim 144 wherein the non-cellulosic polymeric fibers comprise polyester.

148. The nonwoven sheet of claim 144 wherein the non-cellulosic polymeric fibers are oriented.

149. The nonwoven sheet of claim 144 wherein the nonwoven sheet has a basis weight of from about grams/meter² to about 250 grams/meter².

150. The nonwoven sheet of claim 144 wherein the nonwoven sheet has an air permeability of at least about 90 Coresta units.

151. The nonwoven sheet of claim 144 wherein the nonwoven sheet has a formation of about 1000 or less.

152. The nonwoven sheet of claim 144 wherein the bacterial filtration efficiency is at least about 99%.

153. The nonwoven sheet of claim 144 wherein the nonwoven sheet may be printed.
